(19) United States
(12) Patent Application Publication
(10) Pub. No.: US 2008/0308575 A1
(43) Pub. Date: Dec. 18, 2008

(54) Dispensing Device for Reducing Loss of Dissolved Gas in a Liquid Outflow and a Method of Using Same

(75) Inventor: Kjetil Naesje, Sandnes (NO)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: SMARTSEAL AS, SANDNES (NO)

(21) Appl. No.: 11/547,448

(22) PCT Filed: Apr. 4, 2005
(86) PCT No.: PCT/NO2005/000113

§ 371 Date: Aug. 28, 2008

(30) Foreign Application Priority Data
Apr. 5, 2004 (NO) 20041397
Jun. 29, 2004 (NO) 20042733

(51) Int. Cl. B67D 1/12; B67D 1/14

(52) U.S. Cl. 222/4; 222/394

(57) ABSTRACT

A dispensing device (2) for reducing loss of dissolved gas in a pressurized liquid (4) flowing via the dispensing device (2) and a method for use of the dispensing device. The method is used for maintaining an overpressure in a propellant gas (80) for the liquid (4), a receptacle being provided with a cap (42) onto which the dispensing device (2) is provided. The dispensing device (2) includes at least one liquid-flow duct (6) comprising at least one constricted longitudinal portion (8). The characteristics of the dispensing device (2) is that it also comprises at least one liquid-flow discharge surface (12) provided downstream of the flow duct (6), and within a gas-filled atmosphere (10) enclosing at least portions of the liquid-flow discharge surface (12), at least during an initial discharge phase of the liquid (4) discharge. The discharge surface (12) is also turbulence-inhibitingly arranged for the discharging liquid (4). Thereby, the liquid (4) may disperse on the discharge surface (12) and be retarded with minimal release of dissolved gas from the discharging liquid (4).

### AREA OF THE INVENTION

The present invention regards a dispensing device for reducing the loss of dissolved gas in a pressurized liquid flowing via the dispensing device, the liquid as an example coming from a liquid storage receptacle. The storage receptacle is hereafter named receptacle.

The invention also regards a method for maintaining an overpressure in a propellant gas for a liquid in a storage receptacle; the receptacle being provided with a cap whereto a dispensing device is arranged.

The dissolved gas can as an example consist of carbon dioxide (CO₂) and/or dinitrogen oxide (N₂O) and/or other liquid soluble gases.

The gaseous liquid might be a beverage, e.g. mineral water, soft drinks, beer etc., and the liquid might exhibit a high overpressure compared to the normal atmospheric pressure at the surface of the earth.

The receptacle mentioned may, as an example, be a drink container, drink bottle, a cask, a barrel, a keg or a can. The receptacle may be pressurised by gas which is liberated from the liquid in the receptacle, whereby the liberated gas acts as a propellant gas for the liquid flow. It may also be pressurised by a separate pressure source, which is associated the receptacle; the pressure source maintaining overpressure therein at least when liquid is dispensed therefrom via the dispensing device. The separate pressure source may be an external or internal container relative to the storage receptacle; the container holding propellant gas, the container preferably being pressure controllable.

### THE BACKGROUND OF THE INVENTION

A regular phenomena regarding consumption of such a gaseous liquid is the gas being gradually liberated from the liquid and escaping at the opening of the storage receptacle. If additional pressure gas is not supplied from an external source, the liberation of gas will gradually make the liquid more or less flat. For a beverage this state will often give the experience of an insipid taste, causing the beverage to turn into bad and/or inferior for a consumer. Due to this the mentioned gas liberation is normally considered as being a problem.

### PRIOR ART AND THE DISADVANTAGE THEREBY

Repeated discharge of smaller volumes of gaseous liquid from a detached receptacle, e.g. a bottle of soft drink, will gradually drain off the dissolved gas from the receptacle. At the same time dissolved gas in the remaining liquid (residual liquid) of the receptacle will be liberated as the volume of the receptacle filled with liquid decreases, the volume filled with gas increases, and the overpressure decreases. The liberation of gas from the liquid takes place particularly when the interior of the receptacle is open to ambient pressure. The gas liberation will be further enhanced in certain conditions, e.g. when the receptacle and its liquid are shaken and/or heated. A lot of liberated gas escapes when the liquid flows directly out of the opening of the receptacle, e.g. when the mineral water, the soft drink or the beer flows out through a bottle outlet or a can opening. During this kind of liquid dispensing, air does normally flow in through the receptacle opening simultaneously with the flow-out of liquid through the same opening. Thereby air is mixed with both the emuent liquid and the liquid remaining in the receptacle. The air is entrained as air bubbles and the mixing normally take place under turbulent flow conditions. Air bubbles and any particles being introduced to or being present in the liquid, e.g. small contaminations, even act as germs for the creation of new gas bubbles in the liquid. Depending on the type of liquid being dispensed, the relations mentioned may cause the creation of foam in the liquid and a considerable increase in the liquid's surface being exposed to the surroundings, leading to a considerable increase of the area through which the dissolved gas can be liberated. In addition to the mentioned air bubbles, the released gas bubbles act as further germs for the creation of bubbles in the liquid. Thereby further foam may be produced in the liquid. The above-mentioned problems are particularly distinctive when using larger bottles and containers for the storage of gaseous beverages, which has made it necessary to limit the size of the liquid receptacle in order to achieve an acceptable quality of the current beverage.

For a receptacle being interconnected with an external pressure source, the overpressure will be established or maintained by means of the pressure source. This pressure source might comprise a pump device, e.g. a manual powered air pump. When larger liquid flow rates are required, the pressure source might comprise an external pressurised gas source, e.g. a carbon dioxide container being interconnected to a cask or similar, maintaining the overpressure therein when the gaseous liquid is tapped off the receptacle. On its way from the receptacle the liquid has to flow along a flow path and further through a dispensing opening, e.g. a discharge cock or a discharge pipe. The flow path might comprise a relatively thin pipe, a hose, a valve device and/or another type of flow restriction. Along the flow path the liquid is exposed to a static pressure drop contributing to the liberation of dissolved gas in the liquid. Thus the liquid flow is supplied with gas bubbles that might produce foam on the surface of the liquid at the dispensing of the liquid. The size of such collection of gas bubbles depends inter alia on the time. The more time it takes for the liquid to move through the mentioned flow path, the longer time is available for the creation of gas bubbles in the liquid. Thereby the size of the gas bubble collection is depending from, among others, the level of the pressure drop, the length of the flow path and the velocity of the liquid flow. However, any small particles or germs within the liquid might even increase the size of the gas bubble collection. All these circumstances represent sources for undesired creation of bubbles and corresponding lack of sparkle in the dispensed liquid. In some occasions the creation of bubbles in the form of foam might be desirable, e.g. due to aesthetic reasons. A layer of foam on to of the beer in a glass is an example of the latter.

If the gaseous liquid in addition is brought into contact with a relatively rough surface during the flow from the receptacle, flow resistance and possibly turbulence is created in the liquid, all according to hydrodynamic laws and the current flow conditions. Such unevenness or roughness may, as an example, be present in the above-mentioned opening of the receptacle, along the mentioned flow path and/or discharge opening, and/or on the internal surface of a drinking glass wherein the liquid is dispensed. One or more such rough surfaces contribute among others to the increase of the creation of bubbles in the liquid flow and thus contribute to the liberation of more dissolved gas from the liquid.

Liberation of dissolved gas might take place both from the residual liquid in the receptacle, from the liquid flow itself and from the liquid after it has been filled into a drinking glass or the like. Moreover, the liberation of gas takes place according to the thermodynamic laws and according to the characteristics of the current gas(es) associated with the liquid.

Moreover, U.S. Pat. No. 5,842,617 discloses an apparatus for dispensing pressurised or aerated beverages, preferably dispensing such beverages at extremely high flow rates and at minimal foaming. The dispensing apparatus is arranged for use at places retailing liquor and it is relatively large and technically complex. Thus, the apparatus is not suitable for nonce-use in connection with e.g. a bottle. Liquid is propelled from its receptacle via the dispensing apparatus and by means of an external pressure source, e.g. a carbon dioxide container. The apparatus comprises a liquid conduit terminating inside a dispensing head with the shape of an enclosing cap. In an operative position the outlet of the liquid conduit is arranged upturned inside the cap. The liquid conduit is extended in the direction of its outlet. A liquid flow path exists between the liquid conduit and the cap, and the lower portion of the liquid flow path is terminated in a tap opening turned downwards. During dispensing of gaseous liquid the liquid will flow through the liquid conduit and ascend towards the outlet and the outlet edge of the conduit. If the conduit extends towards the outlet, the flow velocity of the liquid will diminish in this flow interval. According to U.S. Pat. No. 5,842,617 the mentioned upward flow will cause most of the pressure and velocity energy of the liquid to be converted to potential energy prior to the liquid's arrival at the outlet edge of the conduit. Thus the liquid should be able to flow over the outlet edge and flow downward mainly by means of the gravity, whereafter the liquid pours from the mentioned tap opening. This flow progress shall prevent the liquid from splashing from the conduit's outlet thereby producing foam in the outflowing liquid. The upward flow of the liquid towards the outlet edge result in liquid pressure drop and liquid velocity reduction, thus causing liquid pressure to diminish towards normal atmospheric air pressure at the outlet edge of the conduit. However, this contributes to undesired liberation of foam producing gas bubbles in the liquid flow. According to U.S. Pat. No. 5,842,617 the dispensing device is also arranged for large flow rates. This implicates that the liquid flow velocity and thereby the velocity energy over the mentioned outlet edge is considerable, which easily leads to undesired and foam producing liquid splash and turbulent flow downstream the outlet edge This effect is enhanced if the liquid due to a relative large propellant pressure also exhibits a static overpressure at the outlet edge. Any germs in the form of gas s bubbles or small particles in the liquid will also enhance the foam growth. It is therefore considerably probable that the dispensing apparatus does not function according to the disclosures of U.S. Pat. No. 5,842,617. Most likely it will cause large losses of dissolved gas and production of too much foam in the dispensed liquid.

### THE PURPOSE OF THE INVENTION

The primary purpose of the invention is to avoid or to reduce disadvantages and problems with the above-mentioned prior art.

More specifically the purpose is to provide a dispensing device to reduce the loss of dissolved gas in a pressurised liquid flowing via the dispensing device. When the liquid is kept in an appurtenant storage receptacle, losses of dissolved gas may occur during the storage of the liquid in the receptacle as well as during the flowout of liquid from the receptacle and after the liquid has been dispensed therefrom. Thus, the invention seeks to keep as much as possible of the gas dissolved in the liquid during the entire progress of use.

The liquid flow via the dispensing device should even be controllable, at least by start and stop.

A further purpose is to provide a functionally improved and constructionally simplified dispensing device for pressurised, gaseous liquids, particularly beverages.

A purpose of the invention is also to provide such a dispensing device at a substantially lower cost than that of prior art dispensing devices.

A further purpose is to provide a method of using the present dispensing device in connection with a cap associated with a storage receptacle for the mentioned liquid.

### How the Purposes are Achieved

The purposes are achieved by features disclosed in the following description and consecutive patent claims.

According to the invention the dispensing device comprises at least one liquid flow duct comprising at least one constricted longitudinal portion. The distinctive is characteristic of the dispensing device is that it comprises at least one liquid discharge surface arranged downstream the liquid flow duct and in a gaseous atmosphere enclosing at least portions of the liquid discharge surface, at least during the initial discharge phase of the liquid, and that the mentioned discharge surface is arranged to inhibit the turbulence of the outflowing liquid. Thereby the liquid may spread over the discharge surface being retarded with a minimal deliberation of dissolved gas from the emuent liquid.

The dispensing device is preferably allocated to a closing device for the liquid flowing via the dispenser.

The device also comprises a method of maintaining an overpressure in a propellant gas of the liquid in the storage receptacle; the propellant gas is deliberated from dissolution in the liquid. The mentioned overpressure shall be maintained over the entire liquid dispensing period from the receptacle. The storage receptacle is provided with a cap whereto the above-mentioned dispensing device is allocated. The distinctive characteristic of the method is that it comprises:
arranging the liquid with a larger saturation of dissolved propellant gas than a corresponding reference saturation rate prior to the liquid being filled onto the receptacle; and
thereafter to underfill the receptacle with the liquid to a liquid level less than a reference liquid level. Thereby the receptacle keeps a supplemental volume wherein the propellant gas can be deliberated in order to maintain the mentioned overpressure during the mentioned dispensing period.

The liquid acts according to the hydrodynamic continuity equation and Bernoulli's pressure equation while flowing through the mentioned flow duct.

Downstream the discharge surface the liquid further preferably flows by means of the gravity and preferably to be collected in a drinking glass or similar.

The present dispensing device may be arranged within a cap for a storage receptacle, it might, however, also be allocated to a discharge device for the liquid, e.g. a discharge cock, discharge pipe or similar, the discharge device is, as an example, interconnected with the receptacle. The receptacle should even be used for e.g. mixing concentrate in the liquid. Furthermore the dispensing device could be connected to a delivery pipe interconnecting the dispensing device to a bottom or side of the liquid receptacle. By means of the dispensing device it is even possible to maintain an acceptable quality of a gaseous beverage even when stored in larger bottles and containers.

The Closing Device:

If a closing device for the flowing liquid is used, the device may be manually or automatically operated. It may as an example consist of a manually activated valve, a solenoid valve, a ball valve or any other suitable closing device. Thereby the liquid may be kept closed in an appurtenant storage receptacle when the closing device is closed. The closing device may be included in the dispensing device. As an alternative it may exist as a separate closing device, which at least in an operative position is connected to the dispensing device. The closing device is preferably arranged upstream of the dispensing device. If the closing device is arranged downstream of the dispensing device, this will cause the dispensing device to be exposed to build-up of pressure and liquid all the way to the closing device. Thus, the dispensing device should be arranged for full pressure load, and liquid has to be removed from the discharge surface of the dispensing device in order to allow this to get in contact with the gas atmosphere during the flowout on the mentioned surface.

The Gas Atmosphere:

As mentioned, the gaseous atmosphere encloses at least portions of the mentioned liquid discharge surface(s) on which the liquid is spread, at least during the initial discharge phase. The gas atmosphere would normally consist of air at normal atmospheric pressure. The atmosphere may also consist of another gas, as an example carbon dioxide, and the gas atmosphere may be different from normal atmospheric pressure. The gas atmosphere may also include gas deliberated from the liquid flow, e.g. carbon dioxide and/or nitrous oxide. Such gas atmosphere shows a very low specific gravity relative to the specific gravity of the liquid, causing the liquid to collide with lightweight gas particles during flowout. This is counteracting gas deliberating and foam producing turbulence in the liquid. The liquid flowout in a gas atmosphere makes it also easy for any deliberated gas bubbles to escape from the liquid instead of mixing with the liquid and possibly create foam. The gas atmosphere also constitutes an easily shapable interface towards the liquid making it possible for the liquid to take a natural flowout shape.

The Flow Duct:

One essential condition for the present invention to function as intended, is that the increase of the liquid's flow velocity through the flow duct is rapid and takes place over a relatively short distance. As mentioned, this velocity increase follows the hydrodynamic continuity equation and Bernoulli's pressure equation. Such a flow progress reduces the time available within the flow duct for deliberation of gas from the liquid and creation of gas bubbles therein, thus counteracting the accumulation of gas bubbles in the liquid. Therefore, the at least one flow duct should be relatively short. In addition the flow duct is preferably arranged turbulence inhibiting to the flowing liquid. Thus, the change of liquid's potential energy and the flow friction loss are insignificant when the liquid flows through the flow duct, the energy balance of the liquid thus mainly consisting of velocity energy (dynamic pressure) and pressure energy (static energy). As the flow duct comprises at least one constricted longitudinal portion with reduced flow cross-section area, which increases the flow velocity of the liquid, the flow duct mainly serves to convert pressure energy to velocity energy. Thereby the gaseous liquid exhausts from the flow duct at a higher velocity and with higher velocity energy, and simultaneously with reduced static pressure and pressure energy.

However, the latter drop in the static pressure of the liquid contributes to the deliberation of undesired gas bubbles from the liquid. The liberation of gas may be counteracted by arranging the flow duct with a longitudinal flow section profile causing the static liquid pressure immediate downstream of the flow duct to be approximately equal to the mentioned gas atmosphere pressure, and being suitable in relation to the current state of flow.

The at least one flow duct may exhibit any geometric cross-section shape and longitudinal section profile.

The flow duct may be peripheral closed and may comprise at least one of the following flow elements with a suitable cross section shape: a pipe, a nozzle and a nozzle tube.

The flow duct may also comprise a constricted flow path being defined between at least one first flow element and at least one second flow element in the dispensing device. By a suitable assembly of the flow elements, the elements cooperate to create the constricted flow path. As an example the flow elements may be assembled to form a split shaped outlet opening between a liquid flow pipe constituting the mentioned first flow element, and a liquid discharge surface of the mentioned second flow element, cf. the embodiments of the invention.

The flow duct, whether it comprises one or more flow elements, may as an example be made of metal, plastic and/or any type of suitable material.

The flow duct may also be made of a flexible material, e.g. plastic or metal, including brass, allowing changing of the flow cross-section along at least one longitudinal portion of this. Thereby an outlet aperture of e.g. a nozzle tube can be reduced or increased by squeezing or any other type of change of shape.

As an alternative, the liquid flowout may be started, stopped and/or adjusted by turning at least one of the mentioned flow elements relative to each other.

The flow duct is preferably arranged turbulence inhibiting in order to inhibit the creation of bubbles during liquid through-flow. This may be achieved by arranging the duct with a smooth inside, particularly at its outlet and/or at its most constricted passage, where the liquid velocity is at its highest.

Furthermore, the flow duct's outlet should have an abrupt termination, such that gas particles from the mentioned downstream gas atmosphere quickly obtain contact with the liquid flowout following this with as little hindrance as possible. The flow duct should be arranged so that it causes a best possible uniform and homogeneous, preferably laminar, and concentrated liquid flowout before flow hits and disperse on the mentioned discharge surface. Thereby the entrainment of gas, e.g. air, in the liquid prior to the flow hits the discharge surface, is reduced. The flow may have any suitable angle of incidence and position relative to the discharge surface.

The Discharge Surface:

Another substantial condition for the invention to function as intended, is that the liquid flow is dispersed on the mentioned turbulence inhibiting discharge surface. It the liquid flow is a liquid jet, the discharge surface may have a liquid spreading shape. However, if the liquid flows via a constricted flow path arranged between the mentioned separate flow elements, the liquid may start to spread over the discharge surface already in the constricted longitudinal portion of the liquid flow duct. At both liquid flow progresses the depth of the liquid is decreased as the liquid's contact area to the discharge surface is increased. Even though the discharge surface is arranged turbulence inhibiting in order to counteract gas deliberation and bubble creation in a boundary layer of the liquid flow coming in contact with the discharge surface, the discharge surface will perform a velocity reducing flow friction over an increased contact area of the liquid flow. Thus, the flow friction per liquid area unit is relatively small, while the total flow friction over the entire contact area of the liquid dispersion is relatively large. Simultaneously a substantial portion of the velocity energy of the liquid flow is used to overcome internal shear forces within the liquid, particularly in said boundary layer, when the liquid is dispersed over the discharge surface. In this way most of the velocity energy of the liquid flow is consumed without encouragement of bubble creation in the liquid flow.

In order for the at least one discharge surface to be arranged turbulence inhibiting, the discharge surface is preferably smooth and exhibits low roughness coefficient. Mirror smooth surfaces with a very low roughness coefficient offer an optimum turbulence and bubble creation inhibiting function for the liquid flow. The discharge surface may as an example be made of plastic with a smooth surface, glass or polished metal.

The discharge surface may even be arranged to be turbulence inhibiting by means of suitable surface treatment of the discharge surface. By adding a viscous material to the discharge surface, a flow turbulence inhibiting function for the liquid may be achieved. Such a viscous material may e.g. comprise sugar, pectin, starch, gel and/or modified polymers. The viscous material is added to or encapsulated in a surface layer of the discharge surface. The viscous material may, as an example, be added to a discharge surface made of plastic. Alternatively the viscous material may be added as a coating after moulding of such a discharge surface in plastic, possibly by means of another surface treatment. Such a surface treatment results in the discharge surface obtaining a low roughness coefficient and thereby a turbulence and bubble collecting inhibiting function for the liquid discharge.

Corresponding turbulence inhibiting materials and/or surface treatment may also be used for the at least one flow duct of the dispensing device.

Furthermore the discharge surface may have any suitable shape. As an example it may be plane, concave, convex, circular, tubular, helical and wavy or it may be assembled by several surfaces, surface types or geometric surface shapes. The discharge surface may also be arranged as a portion of a drinking receptacle, e.g. a drinking glass, into which the gaseous liquid is dispensed. It may also be arranged as a part of a liquid storage receptacle, e.g. as a portion of the outside of the receptacle, or it may be located fully or partly inside the flow aperture of the storage receptacle.

When the present dispensing device is used with no supply of fresh propellant gas and in association with an individual receptacle, e.g. a soft drink bottle, the liquid should hold a sufficient quantity of dissolved gas, thus maintaining an acceptable liquid quality over the entire dispensing period. If the dispensing device is used in association with a receptacle being continuously supplied with fresh propellant gas and/or gaseous liquid, the liquid will, however, hold a stable gas content while it is stored in the receptacle.

### SHORT DESCRIPTION OF THE DRAWINGS

In the following it is referred to embodiments of the invention, where:

FIG. 1 depicts a principle view with a partial cross section of a dispensing device according to the invention, the dispensing device comprising a plane discharge surface;

FIG. 2 depicts same as FIG. 1, the dispensing device is, however, provided with an upstream valve;

FIGS. 3 and 4 depict a view with partial cross sections of another embodiment of the dispensing device, the device depicted in a closed and open position, respectively;

FIGS. 5 and 6 depict partial cross sections of two different embodiments of a discharge surface of the dispensing device;

FIG. 7 depicts a partial cross section of a further embodiment of the dispensing device, the discharge surface of the device comprising a through flow aperture;

FIG. 8 depict in perspective an embodiment of a dispensing device comprising a pipe terminating at the inner surface of a collar;

FIGS. 9 and 10 depict cross sections of an alternative dispensing device arranged in a cap and comprising a flexible activation member, the dispensing device depicted in a closed and open position, respectively;

FIGS. 11 and 12 depict a dispensing device mainly equal to the dispensing device according to FIGS. 9 and 10, where the flexible activation member, however, comprises a helmet shaped valve-closing member;

FIG. 13 depicts a partial cross section of a bottle provided with a cap wherein a dispensing device according to the invention is arranged, the bottle shown in a vertical position of rest;

FIG. 14 depicts a horizontally positioned bottle provided with a cap wherein another type of dispensing device is arranged, the dispensing device being connected to a discharge delivery pipe, the bottle being arranged horizontally in position of rest as well as position of discharge;

FIGS. 15, 16, 17 and 18 depict miscellaneous views of a further cap provided with a dispensing device comprising a manually operated, turnable valve device;

FIGS. 19 and 20 also depict a cross section of a cap provided with a dispensing device comprising is another variant of a manually operated and turnable valve device, the dispensing device shown in closed and open position, respectively, and where the cap in FIG. 19 is provided with a protective cover;

FIG. 21 depicts a cross-section of a cap provided with a dispensing device comprising a adjustment device in the form of a push button for the opening, closing and flow-rate adjustment of through flowing liquid;

FIG. 22 depicts a somewhat modified embodiment of the dispensing device according to FIG. 21;

FIG. 23 depicts a cross-section of another embodiment of the dispensing device arranged in a cap, the device comprising a valve which via a push rod can be activated by means of a manually operated cantilever arm bearing against the push rod;

FIG. 24 depicts a cross-section of a further dispensing device provided in a cap and comprising a plurality of discharge surfaces whereon a liquid may flow upon turning of a wing nut in an associate valve device;

FIGS. 25 and 26 depict, in perspective and cross-section respectively; a further cap provided with a dispensing device comprising another type of valve device, the valve device being activated via a manually operated handle and a spindle bearing against this;

FIGS. 27 and 28 depict cross-sections of the dispensing devices according to FIGS. 19 and 21 respectively; the insides of the dispensing devices on FIGS. 27 and 28 are exposed to high overpressure, however;

FIGS. 29 and 30 depict a cross-section of a further dispensing device arranged at a cap, the dispensing device comprising a drop-shaped flow element connected to an outer adjustment sleeve that is rotatable relative to the cap for thereby adjusting the discharge rate, the dispensing device shown in closed and open position, respectively;

FIG. 31 also depicts a cross-section of a dispensing device arranged at a cap, the cap comprising an outer partition wall surrounded by an adjustment sleeve turnable relative to the cap for thereby adjusting the discharge rate, the dispensing device shown in closed position; and

FIGS. 32 and 33 depict a cross-section of a final embodiment of a dispensing device arranged at a cap, the dispensing device show similarities to the dispensing device according to FIGS. 11 and 12 and comprising a force-transmission stay provided with a cone shaped sealing member, the device shown in closed and open position, respectively.

Moreover, the components in the figures may be shown somewhat simplified and distorted regarding their relative sizes, lengths, transverse dimension etc., but also regarding their relative positions.

### DESCRIPTION OF EMBODIMENTS OF THE INVENTION

Components and elements that are shown in the following embodiments of the invention may be grouped and used in any suitable numbers and in any suitable combinations, not just as shown in the examples. The embodiments may even be combined with other prior art solutions and components within this area.

In the following a particular numeral is used for a specific element, even though the design of the element may differ in the various embodiments.

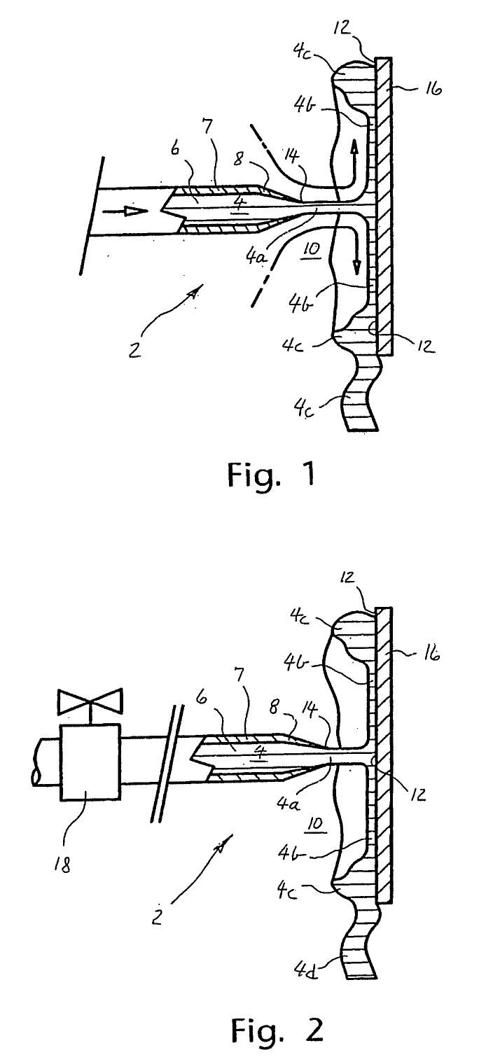

FIG. 1 depicts a dispensing device 2 according to the invention, the figure showing the principle mode of operation of the device when a pressurized and gaseous liquid 4 flows through the device 2. The dispensing device 2 comprises a flow duct 6 defined by a pipe 7, which exhibits a smooth inside wall. In its downstream end the pipe 7 is arranged with a constricted longitudinal portion 8 in the shape of a conical nozzle portion. From the conical nozzle portion 8 the liquid 4 is discharged like a concentrated liquid jet 4a with increased discharge velocity relative to the liquid velocity immediate upstream the pipe 7. The flow direction is indicated with a downstream-directed arrow on the pipe 7. The liquid jet 4a is discharged in a gaseous atmosphere 10 and hits perpendicular on a discharge surface 12, which is provided with a smooth-walled external and arranged at a short distance from the outlet opening 14 of the discharge pipe 7. In this embodiment the atmosphere 10 consists of air at atmospheric pressure. The discharge surface 12 is plane shaped constituting one side of a vertical plate 16. Air 10 is thereby surrounding both the liquid jet 4a and the discharge surface 12, and the liquid jet 4a sets the surrounding air 10 in motion without any essential mixing of liquid and air. Downstream-directed arrows beside the liquid jet 4a indicate the flow direction. After the collision with the discharge surface 12, the liquid jet 4a is dispersed relatively quickly over the entire surface 12 as a relatively thin layered, concentric emuent liquid dispersion 4b. The liquid dispersion 4b is retarded on the plane discharge surface 12 and is accumulated in a somewhat slower flowing, concentric and some thicker liquid formation 4c. By means of the gravity the liquid formation 4c is discharged as a discharge flow 4d from the dispensing device 2. This flow progress reduces the flow speed of the liquid 4 without the creation of unnecessary turbulence therein, thus obtaining minimal deliberation of dissolved gas from the liquid during the flow progress.

FIG. 2 depicts the dispensing device 2 according to FIG. 1. However, the upstream end of the pipe 7 is provided with a closing device 18 in the form of a manually operated valve for the outflowing liquid 4. In order to avoid a long-lasting pressure drop in the pipe 7, such valve 18 should be quickly and completely opened or closed. As an example a solenoid valve or a ball valve may be used for this purpose.

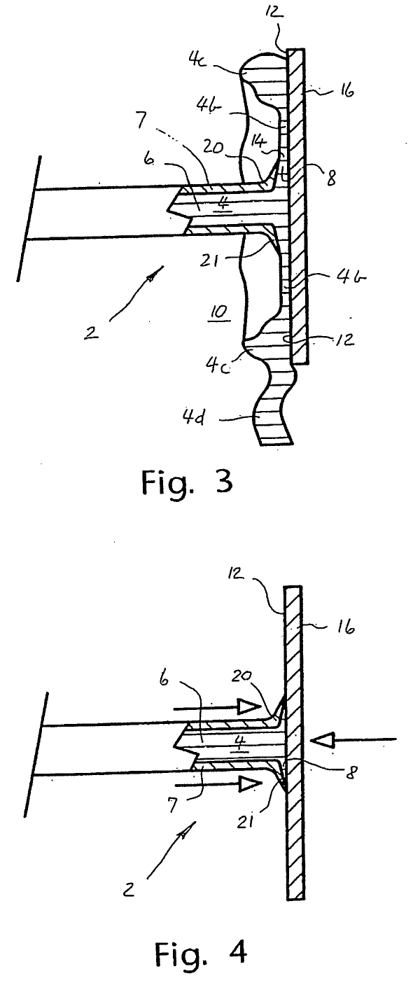

The dispensing device according to FIGS. 3 and 4 also comprises a pipe 7 and a plane discharge surface 12 on a vertical plate 16. The pipe 7 is depicted arranged perpendicular to the vertical plate 16 constituting the mentioned second flow element of the dispensing device 2. In this embodiment the downstream end of the pipe 7 is provided with an external and slanted jacket 20 protruding radially outwards and being arranged at a short distance from the discharge surface 12, the jacket 20 constituting the mentioned first flow element of the dispensing device 2. Cross-sectionwise the jacket 20 is tapered in radial direction ending in an edge at its circumference. The edge thereby constitutes an annular circumferential lip 21. Arranged in this way the jacket 20 and the discharge surface 12 are defining an intermediate and constricted longitudinal portion 8 of the flow duct 6, its downstream end being a circular and slit shaped outlet opening 14. The pipe 7, the jacket 20 and the plate 16 along the longitudinal portion 8 thereby define the flow duct 6. The liquid flows radially from the outlet opening 14 and thereafter like a concentric liquid dispersion 4b on the plane discharge surface 12. The further liquid flow continues as described for the embodiment according to FIG. 1. The liquid flow is preferably laminar and as homogeneous as possible. FIG. 4 depicts the dispensing device 2 in closed position, where the jacket 20 is forced pressure sealingly towards the discharge surface 12 of the plate 16, such that the components 16 and 20 together act as a closing device 18 in the dispensing device 2. Arrows on FIG. 4 illustrate that the components 16, 20 are forced towards each other. However, such a valve function assumes that at least one of the components 16, 20 is arranged moveable relative to the other component. Thereby the flow cross-section and the flow rate of the constricted longitudinal portion 8 may also be controlled. This is favourable in order to adjust the size of the slit shaped outlet-opening 14 in the case of varying propellant pressure of the liquid 4, whereby a steady flow rate is achieved.

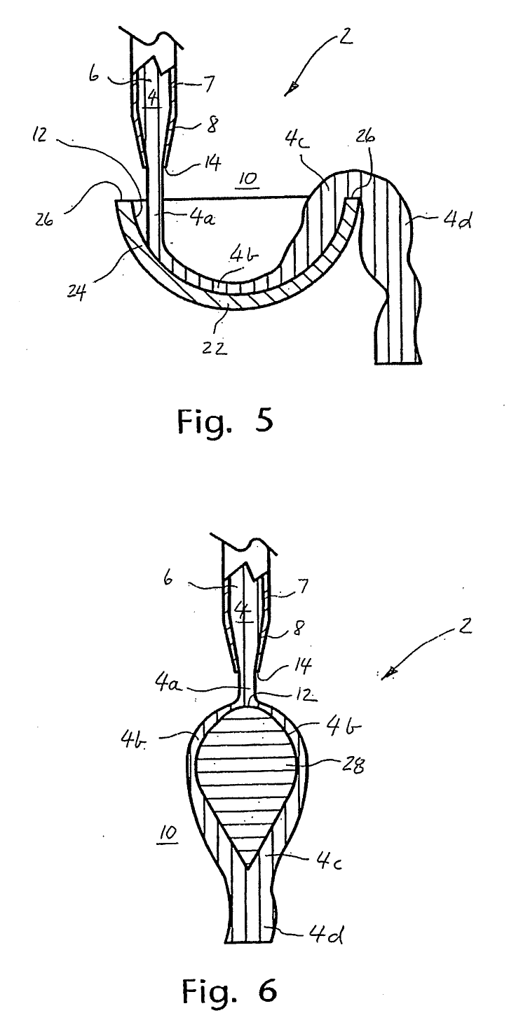

The FIGS. 5 and 6 depict two different embodiments of a discharge surface 12 of a dispensing device 2. As for the embodiment according to FIG. 1, both embodiments make the use of a flow duct 6 which is defined by a pipe 7 with a conical nozzle portion being arranged at a short distance from the discharge surface 12. A liquid jet 4a is discharged vertically from the pipe 7 and hits the surface 12 being surrounded by air 10. Thereafter the jet 4a is dispersed on the surface 12 in a retarding manner as a liquid dispersion 4b. Finally the liquid 4 discharges from the dispensing device 2 as a retarded discharge flow 4d being moved further downwards by means of the gravity. On FIG. 5 the discharge surface 12 constitutes an internal, concave surface of a bowl 22, possibly a trough, provided with a semi-circular cross-section. The liquid jet 4a hits the concave bowl surface 12 an a sharp angle relative to this and in an area 24 close to the side edge 26 of the bowl 22. On the opposite side of said area 24 a retarded and somewhat thicker liquid formation 4c flows over the side edge 26. On FIG. 6 the discharge surface 12 constitutes an external surface of a drop-shaped body 28. The upstream end of the body 28 is blunt and convex shaped, while the downstream end terminates in a point. The liquid jet 4a hits the concave end of the surface 12 at a right angle and is dispersed in a retarding way as a liquid dispersion 4b on all sides of the surface 12. The liquid 4 is concentrated in a somewhat thicker liquid formation 4c about the pointed portion of the surface 12 before it is discharged from the dispensing device 2.

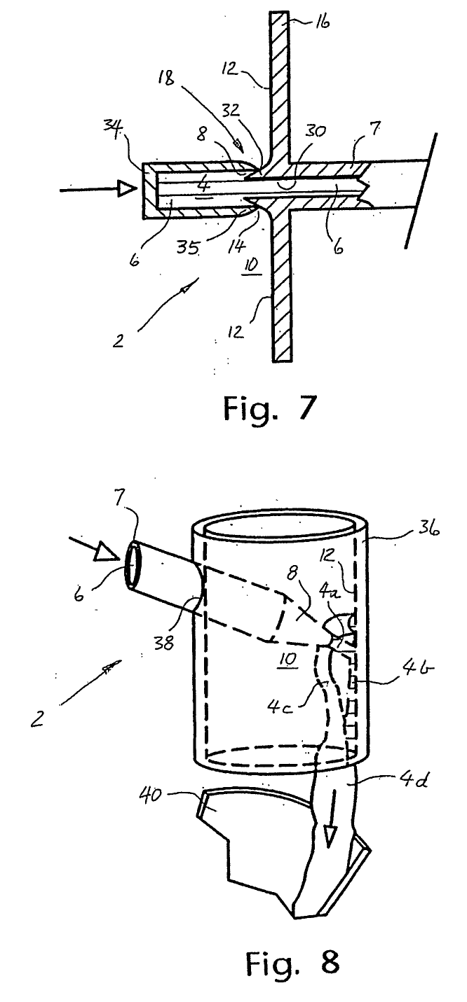

FIG. 7 depicts an alternative way of guiding the liquid 4 through a dispensing device 2. Here the dispensing device 2 comprises a plane-shaped vertical plate 16 provided with a through flow aperture 30. In this embodiment the plate 16 is interconnected with a pipe 7 surrounding the upstream side of the aperture 30. However, such a pipe 7 is optional and is not required to make the dispensing device 2 function as intended. On its downstream side the aperture 30 is surrounded by an annular, conical collar, which external diameter is decreasing in downstream direction. The collar 32 is arranged concentric about the axis of the aperture 30, the collar 32 of the plate 16 constituting the mentioned second flow element of the dispensing device 2. A sleeve cup 34 formed with an open and chamfered end 35 is also arranged concentrically about the mentioned aperture axis and surrounding the collar 32. The internal of the sleeve cup 34 thereby acts as a liquid chamber. The chamfered end 35 of the sleeve cup 34 constitutes the above-mentioned first flow element of the dispensing device 2. In this embodiment the flow duct 6 of the dispensing device 2 is defined by the pipe 7, the plate 16 about the flow aperture 30, and the sleeve cup 34. The constricted longitudinal portion 8 the flow duct 6 is defined by the mentioned chamfered end 35 and the conical collar 32, whereby the outlet opening 14 of the duct 6 is circular and slit shaped. Furthermore the sleeve cup 34 and the plate 16 are arranged moveable relative to each other along the mentioned aperture axis, the size of the slit-shaped outlet opening 14 thereby being adjustable. FIG. 7 depicts the outlet opening 14 in closed state, the arrow in the figure illustrating that the components 32 and 35 are forced towards each other. Together the components 32, 35 operate as a closing device of the dispensing device 2. When the outlet opening 14 is open, liquid 4 may flow onto the discharge surface 12 as described for the embodiment according to FIG. 1. The dispensing device 2 according to FIG. 7 should also function without a collar 32.

The dispensing device 2 according to FIG. 8 is similar to the embodiment according to FIG. 5, and the device 2 comprises a pipe 7 with a conical nozzle portion 8 and a concave discharge surface 12. Differently from FIG. 5, the discharge surface 12 of the dispensing device 2 comprises at least a portion of an internal wall surface of a sleeve 36, the wall being provided with a through hole 38. In this example the sleeve 36 is arranged vertically and is open in both ends. A portion of the pipe 7 and the nozzle portion 8 are lead through the hole 38, the nozzle portion being arranged at a short distance from the discharge surface 12. The liquid jet 4a is discharged downwardly aslant and in air 10, thereafter hitting the concave sleeve surface 12 at a sharp angle relative to this. Thereafter the liquid jet 4a is dispersed on the vertical surface 12 and then discharging as a retarded discharge flow 4d into a drinking glass 40. Downstream direction is indicated with an arrow in the figure. The dispensing device 2 according to FIG. 8 should even function if the upper end of the sleeve 36 is closed. It is obvious that the sleeve 36 might be arranged non vertical and that the liquid jet 4a might discharge at a different angle and at a different distance from the discharge surface 12 than that depicted on FIG. 8.

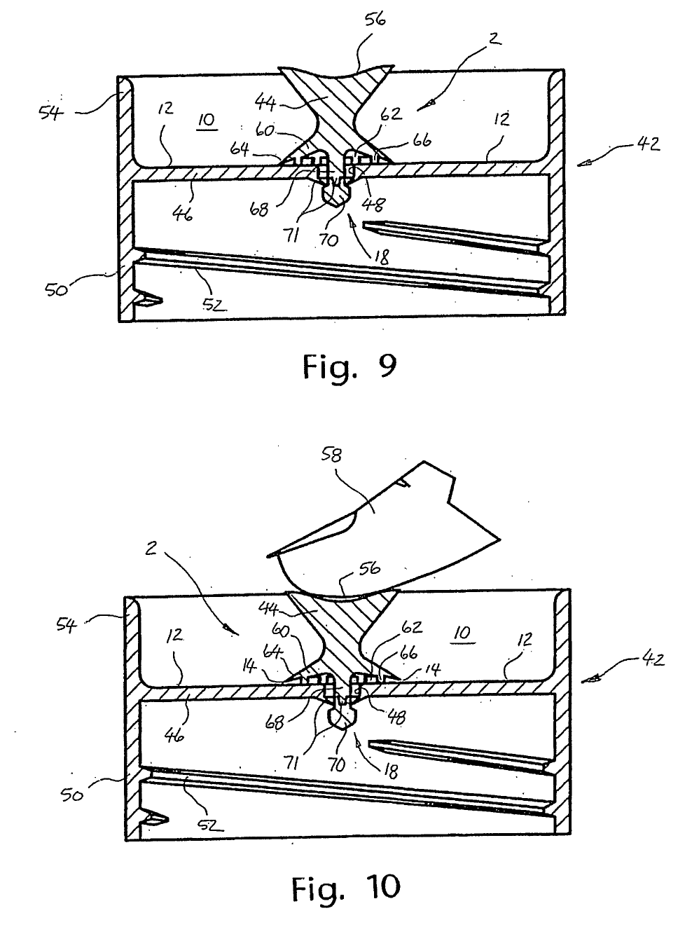

The FIGS. 9 and 10 depict a dispensing device 2 being arranged in a cap 42. The dispensing device 2 comprises a flexible activation body 44, which is connected on the external of a partition wall 46 in the cap 42 and around a through-going wall opening 48 of the partition wall 46. The partition wall 46 constitutes the above-mentioned lower flow element of the dispensing device 2 and separates the cap 42 in an internal connecting portion 50 and an external jacket portion 54. The connecting portion 50 is provided with threads 52 for connection with an associated bottle (not shown), which in an operative state is exposed to an overpressure P. The jacket portion 54 is enclosing and protecting the flexible activation body 44.

The dispensing body 44 is arranged concentric around the wall opening 48 and protrudes from this. At it external end the flexible activation body 44 is shaped like a pressure face 56 whereon a finger 58 (cf. FIG. 10) may perform an axial pressure force pushing the body 44 towards the partition wall 46 and opens the dispensing device 2 for discharge of liquid (not shown) from the mentioned bottle.

At its internal end the flexible activation body 44 is shaped as a concentric and dome-shaped jacket protruding radially outwards enveloping the wall opening 48, corresponding to the jacket 20 of FIGS. 3 and 4. In this example the jacket 60 and partition wall 46 are defining an intermediate, lens-shaped flow region 62 comprising even the constricted longitudinal portion 8 of the dispensing device 2. The jacket 60 constitutes the above-mentioned first flow element of the dispensing device 2, the device 2 acting according to the same flow principles as described for the embodiment according to FIGS. 3 and 4. Cross-sectionwise the jacket 60 is tapered in radial direction terminating in an edge at its circumference. The edge thereby creates an annular peripheral lip 64 corresponding to the peripheral lip 21 of FIGS. 3 and 4. When the activation body 44 is in a position of rest (cf. FIG. 9) the peripheral lip 64 is bearing pressure sealingly towards the partition wall 46. Thereby undesired particles and similar are prevented from intruding into the flow region 62. The sealing arrangement acts as a valve 18 in the dispensing device 2.

At its inside and immediately within the sealing lip 62 the jacket 60 is provided with peripheral evenly distributed spacer knobs 66 protruding axially inward in the direction of the partition wall 46 bearing against this, independent of the dispensing device 2 being open or closed. The spacer knobs 66 constitute a length allowing the circumferential lip 62 pressure sealingly resting against the partition wall 46 (cf. FIG. 9) when the activation body 44 is in a position of rest. The peripheral distribution of the spacer knobs 66 also results in flow apertures existing between those.

Along its centre line the activation body 44 is also provided with a force-transmission stay 68 protruding downward through the wall opening 48 and which in its free end is provided with a concentric and head-shaped fastener knob 70 for the attachment of the body 44 to the partition wall 46. The fastener knob's 70 neck is supported by radially oriented and peripheral evenly distributed one-way flaps 71 being arranged around the wall opening 48 at the inside of the partition wall 46. The flaps 71 protrude aslant into the internal connecting portion 50 of the cap 42 thereby preventing the activation body 44 from getting loose from the partition wall 46. The peripheral distribution of the one-way flaps also causes flow apertures to be present between those at any time.

In order to open the dispensing device 2 for liquid discharge, the flexible activation body 44 is pushed inward towards the partition wall 46. At such inward pushing the mentioned spacer knobs 66 act as rotation points about which the mentioned push force perform a torque lifting the circumferential lip 64 of the jacket 60 away from its support on the partition wall 46. Thereby a circular and slit shaped outlet opening 14 is established (cf. FIG. 10) through which liquid in the above-mentioned way may flow into air 10 dispersing over the discharge surface 12, here consisting of the outside of the partition wall 46 and the inside of the mentioned jacket portion 54. The partition wall 46 about the wall opening 48, the jacket 60 and the partition wall 46 thereby define the flow duct 6 of this dispensing device 2. Adjusting the axial compressive force on the activation body 44 might control the flow rate.

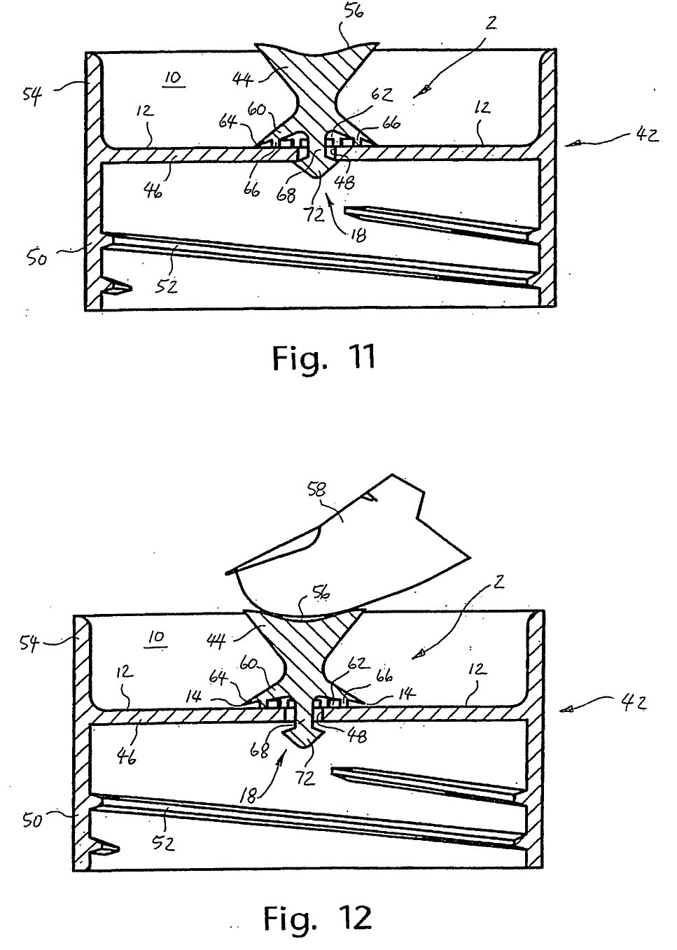

The dispensing device 2 according to FIGS. 11 and 12 is basically equal to the dispensing device according to FIGS. 9 and 10. FIGS. 11 and 12 depict the dispensing device 2 in closed and open position, respectively. However, in this embodiment the partition wall 46 is not provided with one-way flaps 71. Furthermore, the force-transmission stay is provided with a concentric and helmet shaped sealing body 72 somewhat wider than the wall opening 48 and arranged inside of the wall opening 48. The sealing body 72 also acts as an element for the attachment of the activation body 44 to the partition wall 46. When the activation body 44 is in a position of rest and an overpressure P in the mentioned associated bottle is acting on the helmet-shaped sealing body 72, the neck of the sealing body 72 is pushed towards the partition wall 46 in a pressure-sealing manner (so-called positive sealing). This sealing arrangement acts as a valve 18 in the dispensing device 2. In order to open the dispensing device 2 for flow of liquid, the flexible activation body 44, and thereby the stay 68, is pushed axially inwards towards the partition wall 46. Thereby the mentioned sealing body 72 is moved away from the partition wall 46, opening for discharge between the components 46 and 72. By means of its design the activation body 44 is arranged to open the sealing body 72 for an initial liquid discharge to the flow region 62 before the circumferential lip 64 has started to lift away from the partition wall 46. This contributes to the avoidance of turbulent flow at the outlet opening 14 and to static pressure drop in the liquid flow to basically take place in the constricted longitudinal portion 8 immediate upstream the outlet opening 14.

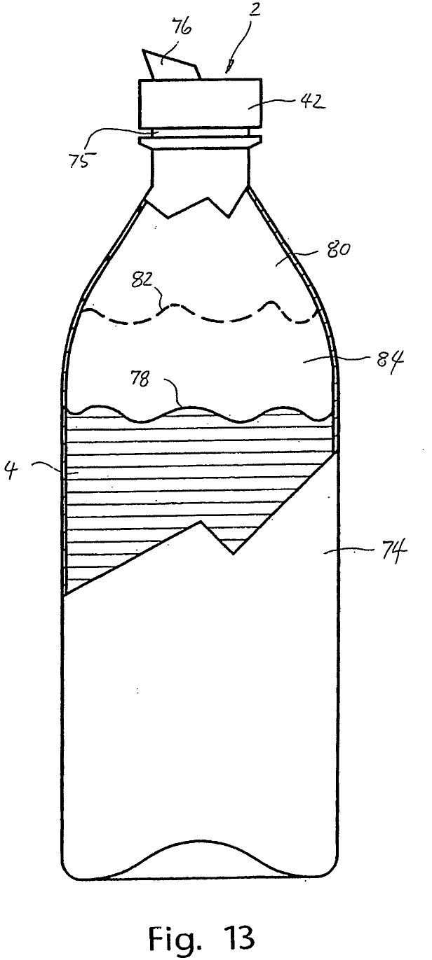

FIG. 13 depicts a bottle 74, the bottle opening 75 of which is connected to a cap 42 wherein a dispensing device 2 is arranged. The cap 42 is also provided with an eccentric pouring spout 76 having a relatively large aperture wherethrough a discharge flow 4d (not shown) may flow from the dispensing device 2. The bottle 74 contains a propellant gas 80, which is deliberated from the liquid 4. According to the present method the liquid 4, prior to the bottling, is arranged with a larger saturation of dissolved propellant gas 80 than that of the normal saturation degree being normal for this kind of liquid 4. Thereafter the bottle 74 is underfilled with the liquid 4 to a liquid level 78 in order to give space for a larger part of propellant gas 80 for the liquid 4. A normal liquid filling degree of the bottle 74 is indicated with the liquid level 82. The bottle 74 thereby contains a gaseous supplemental volume 84 wherein the propellant gas 80 might be deliberated in order to maintain an overpressure within the bottle 74 during the entire dispensing period of the liquid 4 from the bottle 74.

The propellant gas 80 may also be added through the filling of propellant gas immediately after the bottling of the liquid 4. The propellant gas 80 might be filled through a suitable gas filling device or valve arranged within the cap 42 or through a gas-filling valve allocated to the bottle 74. None of these gas-filling devices are shown in FIG. 13.

To leave a supplemental volume 84 of a liquid receptacle 74 for the accumulation of compressed propellant gas 80 within this volume might cause several benefits. By dissolving a relatively large quantity of compressed gas within the liquid 4 of the receptacle, the gas will successively be deliberated and stored in the supplemental volume 84 and possibly create an increased propellant pressure and a larger quantity of compressed propellant gas within the receptacle 74. Thus, a larger volume of liquid 4 might continuously be propelled from the receptacle 74. However, this presupposes that the receptacle 74, its dispensing device 2 and possible other associated equipment are arranged to withstand the topical maximum propellant pressure, which is larger than the propellant pressure present in e.g. a regular gaseous soft drink bottle. Thereby there is no requirement to shake the receptacle 74 to encourage the deliberation of gas, or it is not necessary to wait for dissolved gas to deliberate from the liquid 4 in order to over time build up sufficient propellant pressure within the receptacle 74. For a receptacle 74 arranged for a lower propellant pressure, e.g. a regular soft drink bottle, such an under-filling of liquid 4 would reduce the maximum pressure within the receptacle for a defined volume of dissolved gas within the liquid 4, causing less strain to the dispensing device 2 as well as the receptacle 74. At an increased temperature gas will deliberate from the liquid 4, the liquid thus containing less dissolved gas, which reduces the risk of creating gas bubbles/foam during the dispensing of the liquid 4. In order to achieve a quicker gas deliberation and pressure build-up within the bottle under such conditions, gas bubble producing germs can be arranged within the receptacle 74. As an example such germs might be unevenness or suitable small particles formed or located within or on the receptacle 74, the cap 42 and/or on other components within the receptacle 74, e.g. on the outside of a flow pipe within the receptacle 74. As an alternative the supplemental volume 84 might be filled with gas after the dispensing of a volume of liquid 4 by the receptacle 74 and/or its cap 42 are/is arranged for the introduction of gas 80 after liquid 4 has been filled into the receptacle 74 and the cap 42 has been fitted.

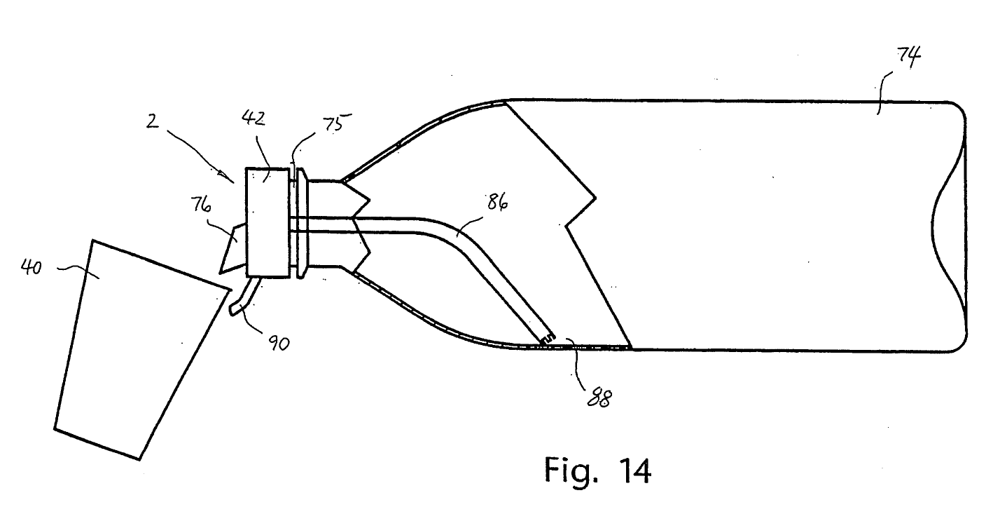

FIG. 14 depicts a horizontally positioned bottle 74 being provided with a cap 42 wherein a dispensing device 2 is arranged, the cap 42 being provided with a pouring spout 76. The cap 42 is interconnected with a discharge riser flow pipe 86 guiding the liquid 4 (not shown) from a lowest located region 88 of the bottle 74 to the dispensing device 2 in the cap 42. The bottle 74 remains stationary in horizontal position during the entire dispensing of liquid 4 therefrom. The dispensing device 2 is also provided with an internal valve device 18 (not shown) for the liquid 4. The valve device 18 is interconnected with an activation lever 90 protruding underneath the pouring spout 76 for the activation of the valve device, said activation lever 90 being pushed towards the cap 42 to open the valve device 18 for liquid discharge. The depicted arrangement makes sure that liquid 4 is available for discharge until the bottle is empty. The bottle 74 might be positioned horizontally e.g. in a refrigerator, such that liquid 4 ay be discharged directly into a drinking glass 40 by pushing this towards the lever 90, thus opening for the liquid discharge.

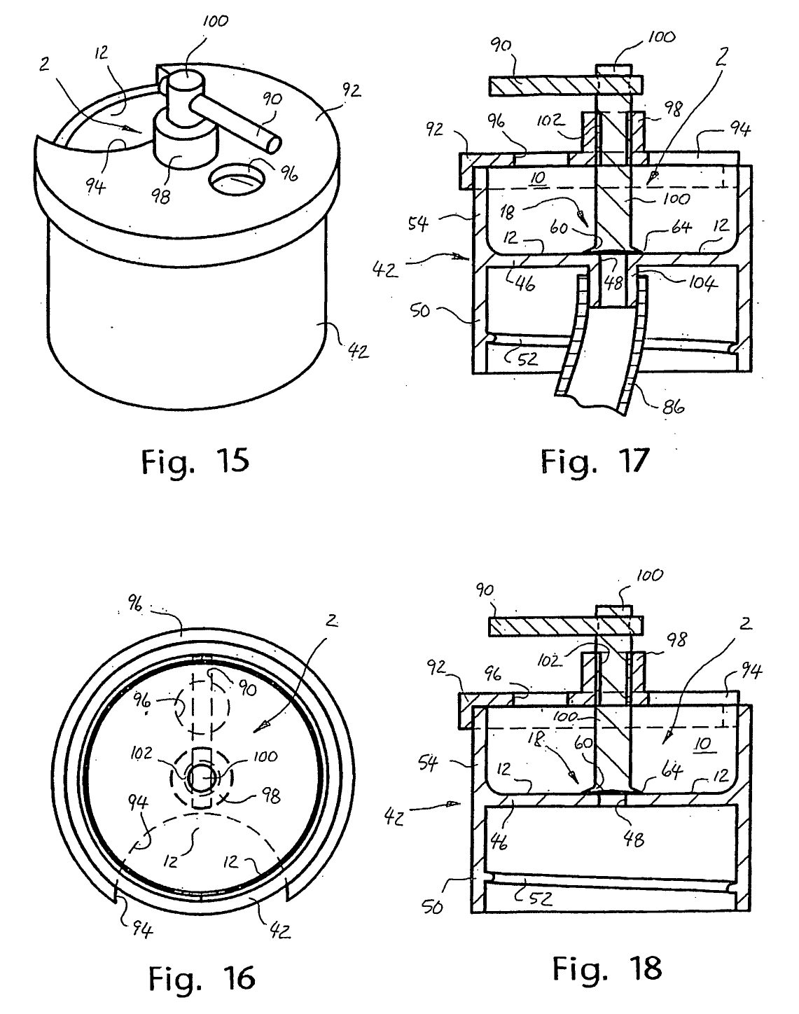

FIGS. 15, 16, 17 and 18 depict in perspective, top view and two sections, respectively, a further cap 42 having a dispensing device 2 comprising a manually operated, turnable valve device 18. As for the embodiment according to FIGS. 9-12 the cap 42 is provided with a partition wall 46 provided with a through wall opening 48, the partition wall 46 constituting the above mentioned second flow element of the dispensing device 2. The partition wall 46 separates the cap 42 in an internal connecting portion 50 with threads 52 and an external jacket portion 54 enclosing the dispensing device 2. In this embodiment the free end of the external jacket portion 54 is interconnected with an enclosing lid 92 wherein are arranged a dispensing opening 94 and a ventilation opening 96. The lid 92 is preferably releasable connected to the cap 42. In its centre the lid 92 is provided with an axially extending external threaded hub 98 wherein a screw spindle 100 is rotatable arranged by means of a threaded connection 102 therebetween. At its outer end the screw spindle 100 is interconnected with an activation lever 90, and at its inner end it is shaped as a concentric and dome-shaped jacket protruding radially outwards enclosing the wall opening 48 by forming an annular circumferential lip 64 (cf. FIG. 9). The jacket constitutes the above-mentioned first flow element of the dispensing device 2. By turning the lever 90, and thereby the screw spindle 100, the lip 64 might be axially moved relative to the partition wall 46 and its wall opening 48. On the FIGS. 17 and 18 the dispensing device 2 is depicted in closed position, the jacket 60 being screwed inward to finally seal against the partition wall 46, the outside of which is arranged as a discharge surface 12 for the dispensing device 2. This sealing arrangement acts as a valve 18 within the dispensing device 2. The jacket 60 and the partition wall 46 also define the intermediate and constricted longitudinal portion 8 (not shown) of the dispensing device 2, as described for FIG. 9. By revolving the screw spindle 100 the flow cross-section and the discharge rate of the constricted longitudinal portion 8 might be adjusted. The discharge progress of the liquid is as described for the FIGS. 9-12. Moreover, FIG. 17 depicts a flow pipe 86 connected to a pipe socket 104 being arranged on the inside of the partition wall 46 and about the wall opening 48.

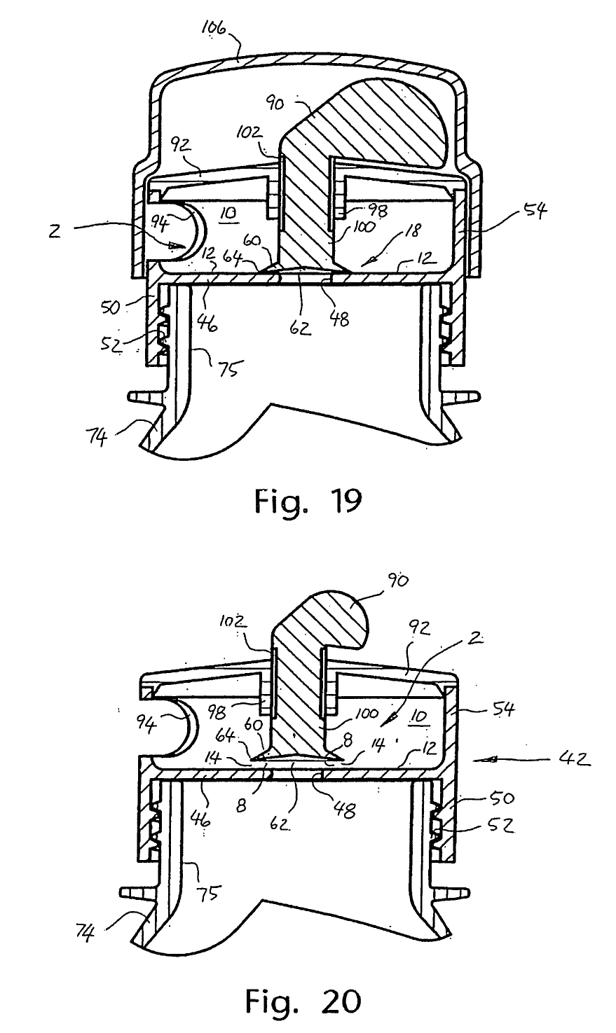

The dispensing device 2 according to FIGS. 19 and 20 is mainly similar to the dispensing device according to FIGS. 15-18, where the cap 42 is shown connected to a bottle opening 75. However, the lid 92 is provided with an internally threaded hub 98, the activation lever 90 is wing shaped and the dispensing opening 94 is arranged in the external jacket portion 54 of a cap 42 being connected to a bottle 74. FIG. 19 depicts the cap 42 provided with a protective cover 106 enclosing the external jacket portion 54 and the dispensing opening 94 therein, the figure also showing the valve 18 in closed position. FIG. 20 shows the valve 18 in open position, wherein the jacket 60 has been screwed outwards in order to open the constricted longitudinal portion 8 of the dispensing device 2 for discharge through its outlet opening 14.

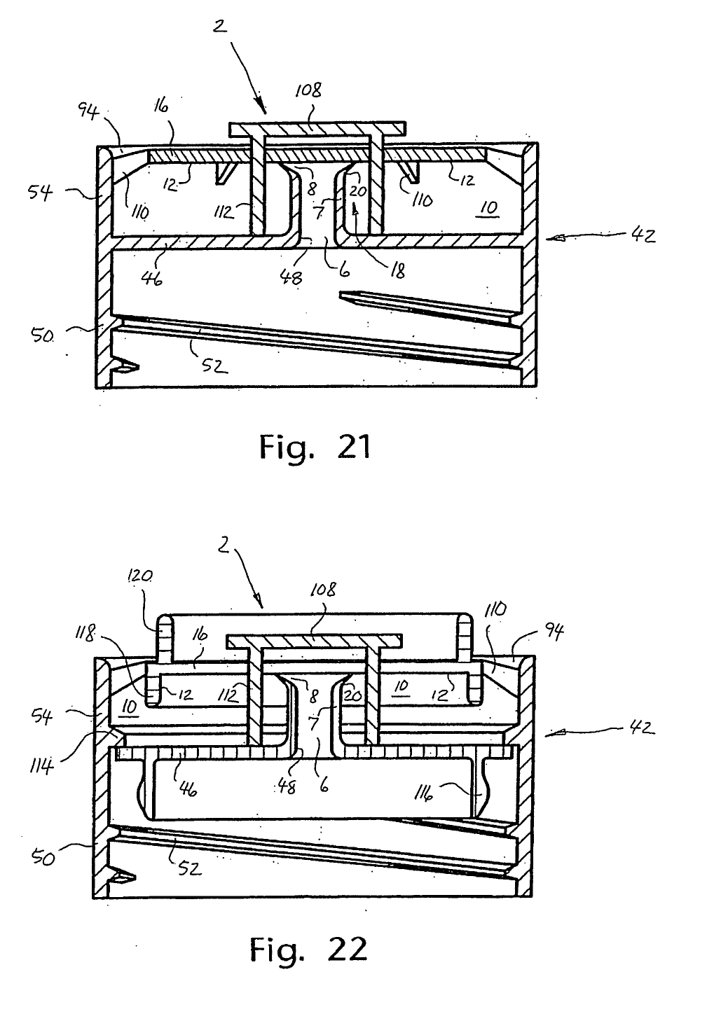

The embodiment according to FIG. 21 is based on the dispensing device 2 according to FIGS. 3 and 4, however, here the device is arranged within a cap 42 that is provided with an adjustment device in the form of a push button 108 for the opening, closing and flow rate adjustment of the dispensing device 2. An axially extending pipe 7 is interconnected at the outside of the partition wall 46 and about its wall opening 48. The free end of the pipe 7 is provided with an external and slanted jacket 20 constituting the above-mentioned first flow element of the dispensing device 2 and which in position of rest is bearing sealingly (cf. FIG. 4) against an externally located circular plate constituting the above-mentioned second flow element of the dispensing device 2. One side of the plate 16 constitutes a discharge surface 12 for a liquid jet 4a (not shown). The plate 16 has a smaller diameter than the inner diameter of the jacket portion 54 and is attached thereto by means of a plurality of peripherally separated attachment brackets 110. A discharge flow 4d (not shown) from the dispensing device 2 will therefore flow via a circular dispensing opening 94 between the periphery of the plate 16 and the jacket portion 54. The push button 108 is arranged outside the plate 16 and is provided with axial legs 112 extending through small holes (not shown) in the plate 16 and which is arranged about the pipe 7 projecting downward to contact with the partition wall 54. In order to open the dispensing device 2 for discharge the push button 108 is exposed to an axial compressive force pushing the partition wall 46 and its interconnected pipe 7 and jacket 20 a short distance inward and away from the plate 16. Thereby a slit-shaped outlet opening 14 for discharge via a constricted longitudinal portion 8, as shown in FIG. 3.

The dispensing device 2 according to FIG. 22 is mainly a modified embodiment of the dispensing device 2 according to FIG. 21. The partition wall 46 is here arranged as a separate plate-shaped unit being located sealingly against an annular seat 114 inside the cap 42. On its inside the partition wall 46 is also provided with a sealing flange 116 arranged to seal against the bottleneck (not shown) when this is screwed tight into the cap 42. The plate 16 is provided with an internal circumferential collar 118 protruding inward, thus increasing the surface of the mentioned discharge surface 12. The plate 16 is also provided with an external circumferential collar 120 protruding outward and protecting the push button 108 against careless pushing. The use of a separate partition wall 46 makes it easier to arrange the partition wall 46 for a specified degree of indentation at the current pressure changes taking place in the associated liquid receptacle.

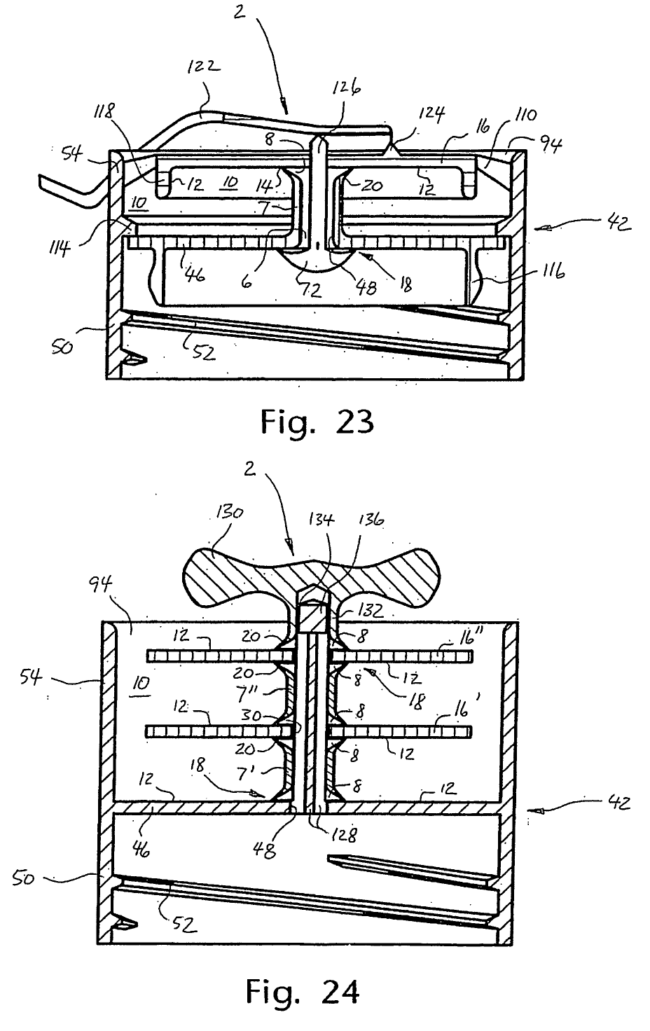

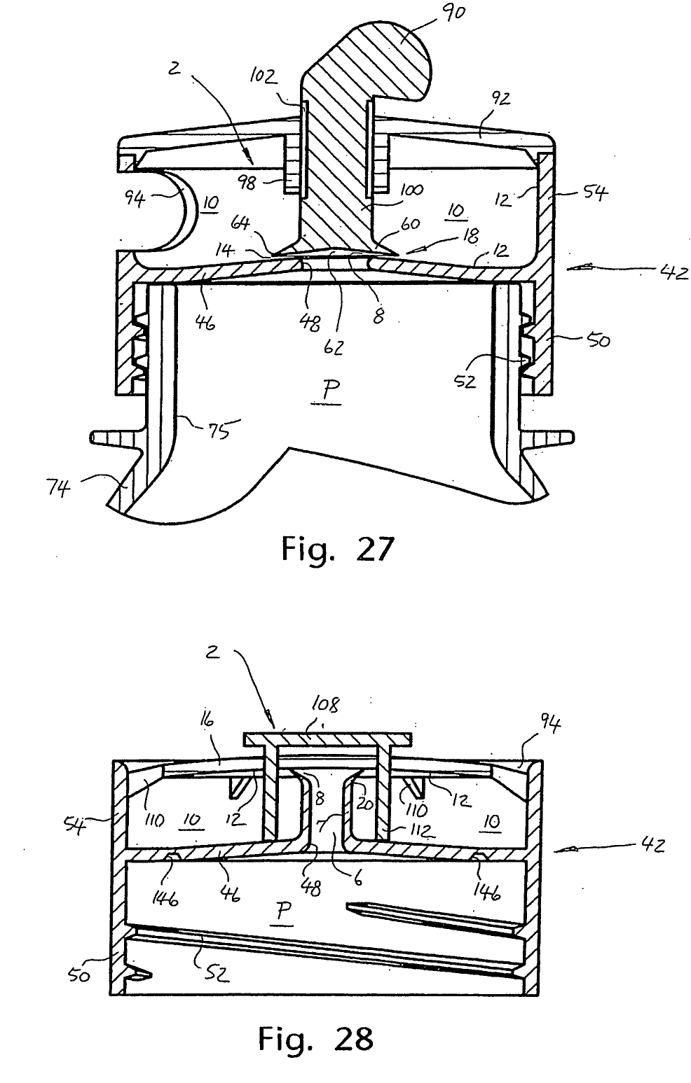

The dispensing device 2 according to FIG. 23 combines elements from FIG. 22 and FIG. 11. However, the circular plate 16 is lacking an external circumferential collar 120 with the advantage of a cantilever arm 122 pivotally connected to the plate 16 in a non-centric point 124, projecting outside the cap 42. The cantilever arm 122 is pivotally connected to and is bearing against an axial push rod 126, which is axial movably arranged inside the pipe 7 and which diameter is substantially smaller than the inner diameter of the pipe 7. Thereby a flow path is obtained between the pipe 7 and the rod 126. In its free end the push rod 126 is provided with a concentric and dome shaped sealing member 72 arranged somewhat wider than the wall opening 48 and being located inside the wall opening 48. When the dispensing device 2 is in a position of rest and an overpressure P in an associated bottle is acting on the dome shaped sealing body 72, the neck of the body 72 is positively pushed towards the partition wall 46 in a pressure-sealing manner. This sealing arrangement acts as a valve 18 in the dispensing device 2. The valve 18 is opened by pushing the cantilever arm 122 and thereby the push rod 126 and its sealing body 72 axially inward towards the partition wall 46 by means of e.g. a drinking glass 40 (not shown). The cap 42 is may, as an example, be connected to a horizontally positioned bottle 74 in a refrigerator as shown in FIG. 14. At a relatively high overpressure P within an interconnected receptacle 74 the partition wall 46 will bend outward in the direction of the plate 16, causing the mentioned slit shaped outlet opening 14 from the pipe 7 become relatively small. This is explained and shown more closely in connection with FIGS. 27 and 28. At a relatively low overpressure P the bending will be relatively smaller, such that the outlet opening 14 becomes relatively large. In this way the discharge rate is self-adjustable at the same time as a positive pressure sealing is achieved. At relatively low overpressure P the valve 18 may also be provided with a biased spring pushing the sealing body 72 sealingly towards the partition wall 46 when the valve 18 is closed.

FIG. 24 also depicts a dispensing device 2 arranged within a cap 42 and based on the dispensing device according to FIGS. 3 and 4. However, in this embodiment is used concentric assembly of more discharge surfaces 12. This dispensing device 2 is arranged for use at relatively large discharge rates, but without increasing the diameter of the cap 42. The wall opening of the partition wall 46 is interconnected to a cross-sectionwise cross-shaped stay 128 protruding axially outward within the external jacket portion 54 of the cap 42. In its longitudinal direction, and in sequence, the stay protrudes through a short pipe 7′ being arranged immediate opposite the partition wall 46, a flow aperture 30 in a first, circular plate 16′, a second, short pipe 7″, a flow aperture 30 in a second, circular plate 16″ and finally into a wing nut 130. Due to its cross-shape, there are totally four axial flow paths between the stay 128 and the components 7′, 7″, 16′, 16″ and 130. The wing nut 130 is arranged with a axially extending short pipe socket 132 open at its lower, free end, the end of which facing the external side of the second, circular plate 16″. The pipe socket 132 includes an internal threaded portion 134 enclosing an external, threaded spindle pin 136 interconnected with the outer end of the cross-shaped stay 128. When the wing nut 130 is turned, the pipe socket 132 is axially moved. The external side of the partition wall 46 and both sides of the first and second plate 16′, 16″ constitute the discharge surfaces 12 for a liquid discharge 4 (not shown), constituting totally five discharge surfaces 12. Both of the axial ends of the first and second short pipes 7′, 7″ and the free end of the pipe socket 132 are provided with external and slanting jackets 20 (cf. FIGS. 3 and 4). When the wing nut 130 is screwed sufficiently in toward the partition wall 46, as shown in FIG. 24, all jackets 20 are forcing towards an associated discharge surface 12 and seal for the liquid 4. This sealing arrangement acts as a valve 18 in the dispensing device 2. However, when the wing nut 130 is screwed sufficiently outward, liquid 4 will flow out on all discharge surfaces 12 via the respective constricted longitudinal portions 8 and slit shaped outlet openings 14 (not shown) between the jackets 20 and the discharge surfaces 12 of the plates 16′, 16″. The discharge flow rate might be adjusted through turning of the wing nut 130. A discharge flow 4d (not shown) from the dispensing device 2 will thereby flow out via a circular dispensing opening 94 between the plates 16′, 16″ and the jacket portion 54.

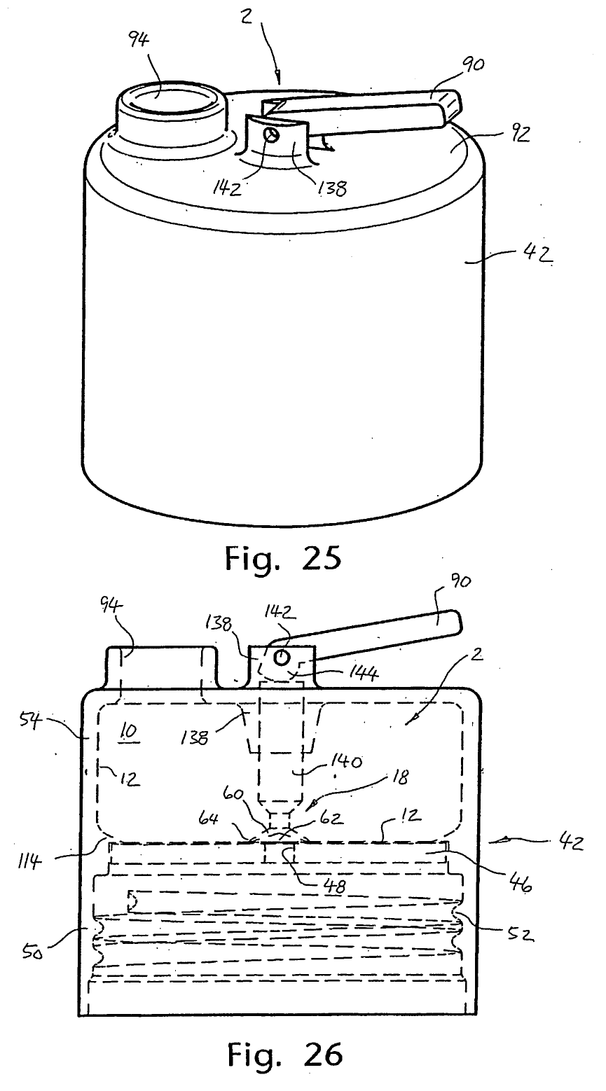

FIGS. 25 and 26 depict a dispensing device 2 with several similarities to the embodiment according to the FIGS. 15-18 and acting according to the same flow principles as described for these and for the FIGS. 3 and 4. In this embodiment the lid 92 constitutes a portion of the cap 42. A dispensing opening 94 is arranged in the lid 92, the opening 94 also serving as a ventilation opening. In its centre the lid 92 is provided with an axially extending, internally smooth hub 138 wherein an externally smooth spindle 140 is arranged axially movable. At its inner end the spindle 140 is provided with the mentioned dome shaped jacket 60 constituting the mentioned annular shaped circumferential lip 64 about the mentioned wall opening 48 of the partition wall 46 of the cap 42. At its outer end the hub 138 is pivotal interconnected with an activation lever 90 via a hinge pin 142 diametric supported in the hub 138. The lever 90 is radially protruding from the hub 138 and at its inner end the lever 90 is connected to an eccentric cam 144 being arranged about the hinge pin 142. The eccentric cam 144 is bearing against the outer end of the spindle 140. When the lever 90 is gradually turned about the hinge pin 142, the spindle 140 is gradually moved in axial direction due to the eccentric shape of the cam 144. Thereby the distance between the partition wall 46 and the circumferential lip 64 is adjusted, including closing for the liquid discharge, but also to adjust the discharge rate from the dispensing device 2. Outflowing liquid 4 (not shown) will be retarded along a discharge surface 12, here constituting of the outside of the partition wall 46 and the internal of the mentioned jacket portion 54. As for the embodiment according to FIG. 22, the partition wall 46 consists of a separate plate shaped unit being arranged sealingly against an annular seat 114 inside the cap 42.

FIGS. 27 and 28 correspond with the embodiments according to FIGS. 20 and 21, respectively, but here the dispensing device 2 is depicted exposed to high overpressure P in the bottle 74. In both embodiments the partition wall 46 bulges axially outward due to the mentioned overpressure. In addition, FIG. 28 shows that the outside located, circular plate 16, of which one side constitutes a discharge surface 12, is axially bent outward due to the overpressure P. In order to conduct the axial bending to a certain region of the discharge surface 12, this is arranged with a circular weakening zone 146. At a relatively high overpressure P inside an interconnected receptacle 74, the partition wall 46 will bend outward in the direction of the plate 16 causing the slit shaped outlet opening from the pipe 7 being relatively small. The smaller outlet opening 14 counteracts and compensates for the increased discharge rate, which otherwise would result from an increased overpressure inside the receptacle 74 at a certain opening position of the lever 90 or the push button 108, whereby the discharge rate is kept approximately stable, even at greatly variable overpressure P within the receptacle 74. In closed position the bending of the partition wall 46 will contribute to an increasing positive sealing pressure and improved sealing state at increasing overpressure P within the receptacle 74.

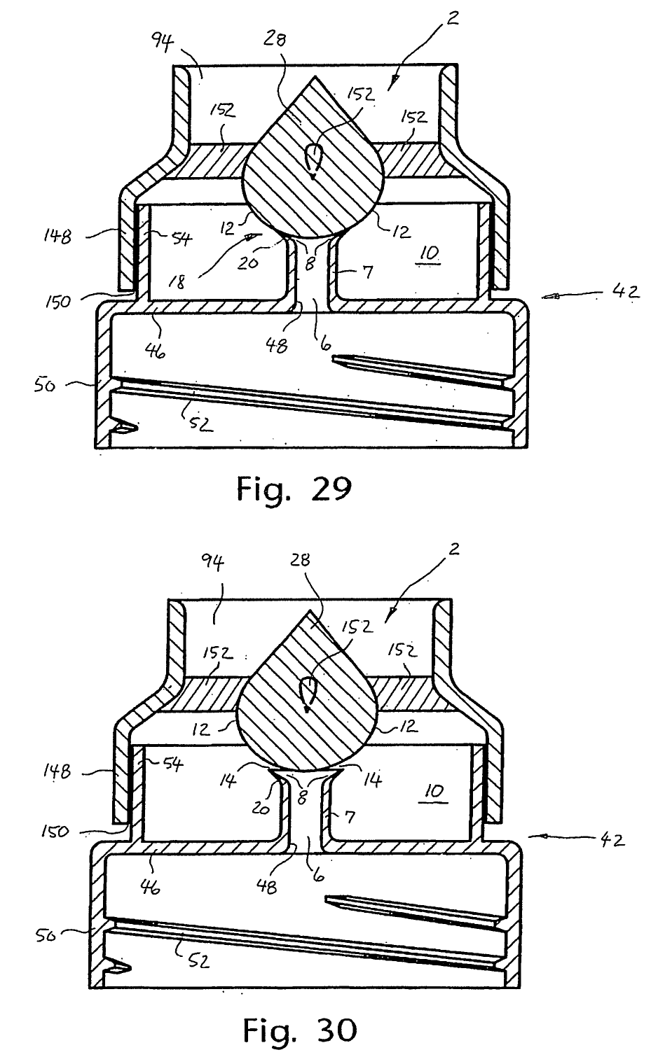

FIGS. 29 and 30 also depict a dispensing device 2 arranged within a cap 42, combining the features of FIGS. 3 and 4, FIG. 6 and FIG. 21. As for what is shown in FIG. 21, the dispensing device 2 according to FIGS. 29 and 30 is provided with an axially extended pipe 7 being connected to the external of the partition wall 46 and about its wall opening 48, the pipe 7 provided with an external and slanted jacket 20. The jacket 20 constitutes the above mentioned first flow element of the dispensing device 2. The external jacket portion 54 of the cap 42 is pivotally interconnected with an enclosing, graduated adjustment sleeve 148 provided with four radially arranged attachments stays 152 (whereof only three stays 152 are shown in the figures) connected to a drop-shaped body 28 (cf. FIG. 6), the drop-shaped body constituting the above-mentioned second flow element of the dispensing device 2. The body 28 is arranged concentric about the longitudinal axis of the pipe 7. In this example the discharge surface 12 of the dispensing device 2 consists of the surface of the drop-shaped body 28. By turning the adjustment sleeve 148 relative to the jacket portion 54, the distance between the jacket 20 and the body 28, and thereby the size of the outlet opening 14, is precisely adjusted, possibly fully closed as shown in FIG. 29. The precision of the adjustment is determined i.a. by the thread pitch of the threaded portion 150. This sealing arrangement acts as a valve 18 in the dispensing device 2. A discharge flow 4d (not shown) from the dispensing device 2 is discharged via a circular dispensing opening 94 between the drop-shaped body 28 and the adjustment sleeve 148.

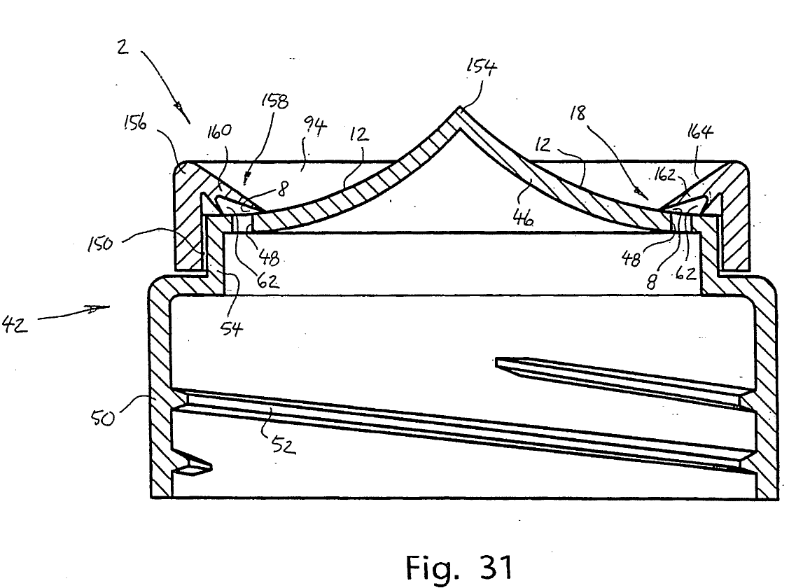

FIG. 31 also depicts a cap 42 with an internal connecting portion 50 and an external jacket portion 54, however, there is no partition wall 46 present between the mentioned portions 50, 54. In this embodiment the partition wall 46 is arranged at the outer end of the jacket portion 54, constituting a somewhat smaller diameter than that of the connecting portion 50. The partition wall 46 is constituting the above-mentioned second flow element of the dispensing device 2, and at its periphery the partition wall 46 provided with more peripheral distributed wall openings 48. The partition wall 46 is designed with a concentric outward deflection terminating in a centre peak 154. Between the peak 154 and the periphery of the partition wall 46 the deflection forms a cross-sectionwise outward concave surface, the external surface constituting the discharge surface 12 of the dispensing device 2. An adjustment sleeve 156 is rotatable connected surrounding the external jacket portion 54 via a threaded portion 150. On its radial internal side the adjustment sleeve 156 is provided with a flexible connection ring, cross-sectionwise formed like a dome shaped and askew jacket 160 protruding radially inward and enclosing the wall openings 48. Assembled in this way the jacket 160 and the partition wall 46 define an intermediate flow region 62 comprising the constricted longitudinal portion 8 of the dispensing device 2. The jacket 160 constitutes the above-mentioned first flow element of the dispensing device 2, the device 2 acting according to the same flow principles as those described for the embodiment according to FIGS. 3 and 4, the FIGS. 9 and 10 and the FIGS. 11 and 12. Cross-sectionwise the jacket 160 forms an internal, annular shaped circumferential lip 162 and a somewhat shorter, external annular circumferential lip 164. By screwing the adjustment sleeve 156 axially inward towards the connecting portion 50 of the cap 42, the circumferential lips 162, 164 will finally bear pressure-sealingly against the partition wall 46, as shown in FIG. 31. This sealing arrangement acts as a valve 18 in the dispensing device 2. When the adjustment sleeve 156 is screwed axially outward, the valve device 18 opens for liquid discharge via the wall openings 48 and the mentioned constricted, longitudinal portion 8 and further out on the external discharge surface 12, which also defines the dispensing opening 94 of the dispensing device 2. The liquid discharge rate is adjusted by rotating the adjustment sleeve 156 relative to the jacket portion 54, thus setting the size of the outlet opening 14 of the dispensing device 2 to a desired level.

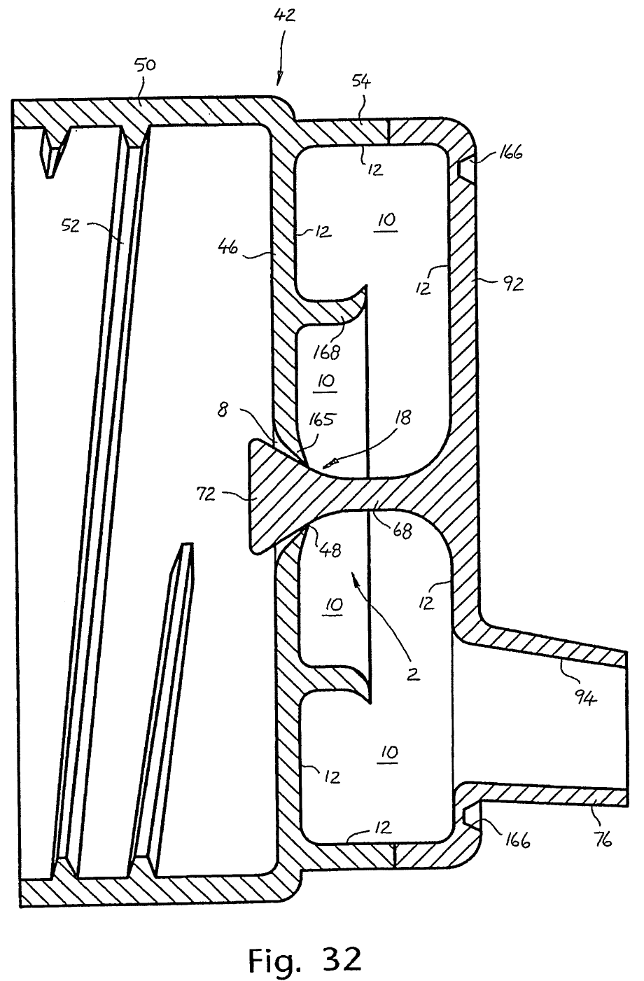

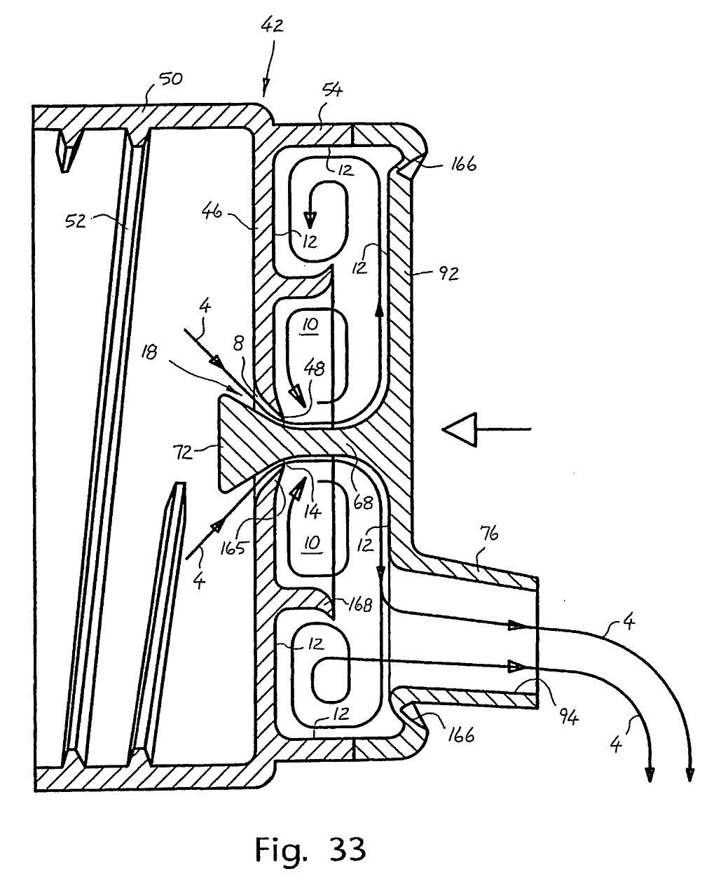

The dispensing device 2 according to FIGS. 32 and 33 has similarities to the dispensing device according to FIGS. 11 and 12. FIGS. 32 and 33 depicts the dispensing device 2 in closed and open position, respectively. In this embodiment the free end of the external jacket portion 54 of the cap 42 is releasably interconnected with a lid 92 provided with an eccentric pouring spout 76 defining a dispensing opening 48, and which in its free end is provided with a concentric and conical sealing body 72 arranged within the wall opening 48. The sealing body 72 constitutes the above-mentioned second flow element of the dispensing device 2. The conical sealing body 72 is extended in upstream direction within the internal connection portion 50 of the cap 42, in which region the body 72 is arranged wider than the wall opening 48. Inside the wall opening 48 the partition wall 46 is provided with a flexible sealing ring 165 protruding into the wall opening 48 tapering in radial direction and terminating in an edge. When the dispensing device 2 is in a position of rest, the conical sealing body 72 is bearing pressure-sealingly against the sealing ring 165, cf. FIG. 32. The sealing ring 165 constitutes the above-mentioned first flow element of the dispensing device 2. This sealing arrangement acts as a valve 18 in the dispensing device 2. At overpressure P inside internal connection portion 50 of the cap 42, the sealing body 72 will, due to its cone shape, be positively and pressure-sealingly pushed toward the sealing ring 165. Assembled in this way, the conical sealing body 72 and the flexible sealing ring 165 define an intermediate flow duct 6 with constricted longitudinal portion 8. When the lid 92 and the stay 68 are axially pushed inwards towards the partition wall 46, the sealing body 72 is moved away from the sealing ring 165, opening for discharge between the components 165 and 72, cf. FIG. 33. In order to control the axial indentation to a defined region of the lid 92, the lid 92 is also provided with a circular weakening zone 166. When the dispensing device 2 is open, the downstream end of the flow duct 6 constitutes a circular and slit-shaped outlet opening 14. Thereby the liquid 4 may discharge into air 10 along the stay 68 being dispersed over the discharge surface 12, here being the inside of the lid 92 and the jacket portion 54 and partly the outside of the partition wall 46. The flow progress of the liquid 4 and the air 10 is indicated with the downstream-directed arrows on FIG. 33. In order to assure that the liquid 4, during its initial discharge phase, discharges into air 10 and to a little extent is mixed with downstream liquid 4, the partition wall 46 is provided with an external circumferential collar 168 surrounding the downstream side of the wall opening 48 and the stay 68. Thereafter the retarded liquid 4 flows out through the mentioned pouring spout 76.

For a person skilled in the art having knowledge of the valve device according to PCT/NO02/00198 and comparing this with the latter embodiment, it would be obvious that an atmospheric pressure P1 acting on the outside of the lid 92 and an underpressure P2 being supplied through the pouring spout 76, together will establish a pressure differential P1−P2 over the lid 92. This pressure differential is pushing the lid 92 and the stay 68 inwards towards the partition wall 46 with a force pushing the sealing body 72 away from the sealing ring 165, thereby opening the liquid discharge. Thus the valve device according to PCT/NO02/00198 may be used together with the present dispensing device to obtain a suction force activated dispensing device.

1. A dispensing device (2) for reducing loss of dissolved gas in a pressurized liquid (4) when flowing via the dispensing device (2), in which the dispensing device (2) includes at least one liquid-flow duct (6) having an outlet opening (14), characterised in that said liquid-flow duct (6) also comprises a constricted longitudinal portion (8) with reduced flow cross-sectional area provided immediately upstream of said outlet opening (14), said liquid-flow duct (6) thus being arranged to increase the flow velocity of the liquid (4) when flowing through said reduced flow cross-sectional area so as to discharge from the outlet opening (14) with an increased velocity;
wherein the dispensing device (2) also comprises at least one liquid-flow discharge surface (12) provided downstream of the flow duct (6) and in contact with a gas-filled atmosphere (10); and
wherein said discharge surface (12) is turbulence-inhibitingly arranged for the discharging liquid (4), whereby the discharge surface (12) is arranged in a manner allowing the accelerated liquid (4) discharging from the outlet opening (14) to disperse onto the discharge surface (12) and retard its velocity whilst experiencing minimal release of dissolved gas from the discharging liquid (4).

2. The dispensing device (2) according to claim 1, characterised in that the liquid-flow duct (6) comprises at least one of the following flow elements that are provided at a distance from the discharge surface (12):
a pipe (7);
a nozzle; and
a nozzle pipe.

3. The dispensing device (2) according to claim 2, characterised in that the discharge surface (12) forms at least a portion of an inner wall surface of a sleeve (36), the wall of which is provided with a through-going aperture (38), wherein at least a portion of said flow element has been inserted through the aperture (38).

4. The dispensing device (2) according to claim 2 or 3, characterised in that said distance from the discharge surface (12) is adjustable.

5. The dispensing device (2) according to claim 1, characterised in that said constricted longitudinal flow portion (8) is defined between at least one first flow element (20, 35, 60, 160, 165) and at least one second flow element (16, 16′, 16″, 32, 46, 28, 72).

6. The dispensing device (2) according to claim 5, characterised in that said first flow element (20, 35, 60, 160, 165) and said second flow element (16, 16′, 16″, 32, 46, 28, 72) are arranged moveable with respect to one another, whereby an outlet opening (14) of the duct (6) is adjustable.

7. The dispensing device (2) according to claim 5 or 6, characterised in that said first flow element comprises an external and slanted jacket (20) that projects radially outwards, and that is arranged in a downstream end of a pipe (7).

8. The dispensing device (2) according to claim 7, characterised in that said second flow element is a plate (16).

9. The dispensing device (2) according to claim 5, characterised in that said first flow element comprises an open and chamfered end (35) of a sleeve cup (34) surrounding a conical collar (32), the outer diameter of which tapers in a downstream direction, wherein the collar (32) is arranged at a downstream side of a plate (16) and around a flow aperture (30) therein, the collar (32) forming said second flow element.

10. The dispensing device (2) according to claim 9, characterised in that an upstream side of the plate (16) is connected to a pipe (7) surrounding the flow aperture (30) in the plate (16).

11. The dispensing device (2) according to claim 5, characterised in that the dispensing device (2) is arranged within a cap (42) that, when in position of use, surrounds an aperture (75) in a storage receptacle (74), and that includes a partition wall (46) having at least one through-going wall opening (48).

12. The dispensing device (2) according to claim 11, characterised in that said first flow element comprises at least one dome-shaped jacket (60, 160) that is associated to the cap (42), and that tapers radially and forms a ring-shaped peripheral lip (64, 162), whereby a flow region (62) comprising said constricted longitudinal portion (8) exists between the jacket (60, 160) and the partition wall (46), the partition wall (46) forming said second flow element.

13. The dispensing device (2) according to claim 12, characterised in that the jacket (60) forms an inner end of a flexible activation body (44) connected to the downstream side of the partition wall (46) and around the wall opening (48) therein; and
wherein the jacket (60), at the inside thereof and immediately inside of the circumferential lip (64), is provided with peripherally distributed spacer knobs (66) projecting inwards in direction of the partition wall (46) and bearing against this wall (46) independently of the dispensing device (2) being open or closed, the spacer knobs (66) acting as pivot points about which a torque may act and lift up the peripheral lip (64) from its contact with the partition wall (46).

14. The dispensing device (2) according to claim 13, characterised in that the activation body (44) is provided with a force-transmission stay (68) allowing bypass-flow and projecting down through the wall opening (48), the free end of the stay (68) being provided with a fastener body (70, 72) for fastening the activation body (44) to the partition wall (46).

15. The dispensing device (2) according to claim 14, characterised in that said fastener body comprises a concentric and head-shaped fastener knob (70), the neck of which is supported against radially extending and peripherally distributed one-way flaps (71) that are arranged around the wall opening (48) at the upstream side of the partition wall (46), and that projects obliquely into the cap (42).

16. The dispensing device (2) according to claim 14, characterised in that said fastener body comprises a concentric and helmet-shaped sealing body (72) that is arranged wider than the wall opening (48), and that is provided within the wall opening (48).

17. The dispensing device (2) according to any one of claims 13-16, characterised in that the flexible activation body (44), at the outer end thereof, is shaped as a pressure face (56) onto which an axial pressure force may act for opening the dispensing device (2) for discharging of the liquid (4).

18. The dispensing device (2) according to claim 12, characterised in that the jacket (60) forms an inner end of a spindle (100, 140) being axial-movably connected to the cap (42).

19. The dispensing device (2) according to claim 18, characterised in that the spindle (100) is rotatingly connected to the cap (42) in order to achieve said axial movement.

20. The dispensing device (2) according to claim 18 or 19, characterised in that the spindle (100, 140) is connected to a lid (92) that is provided with a dispensing opening (94), and that is associated to the cap (42).

21. The dispensing device (2) according to any one of claims 11-20, characterised in that a pipe socket (104) is arranged at the upstream side of the partition wall (46) and around the wall opening (48); and
wherein a delivery pipe (86) is connected to the pipe socket (104) and connects the dispensing device (2) with a bottom (88) or side of the storage receptacle (74).

22. The dispensing device (2) according to claim 12, characterised in that the jacket (160) is a flexible connection ring (158) surrounding several peripherally distributed wall openings (48) in the partition wall (46), in which the connection ring (158) is connected to a surrounding adjustment ring (156) that is rotatably connected to the cap (42) for adjusting the discharge rate of the liquid (4); and
wherein the partition wall (46) is formed with a concentric deflection terminating in a central tapering (154), in which the outer surface of the partition wall (46) forms the discharge surface (12) of the dispensing device (2).

23. The dispensing device (2) according to claim 11, characterised in that said first flow element comprises at least one external and slanted jacket (20) that projects radially outwards, and that is provided in at least one end of at least one pipe (7, 7′, 7″).

24. The dispensing device (2) according to claim 23, characterised in that said first flow element comprises a jacket (20) arranged in the free end of an axially extending pipe (7) connected to the downstream side of the partition wall (46) and around the wall opening (48) thereof.

25. The dispensing device (2) according to claim 24, characterised in that said second flow element is a drop-shaped body (28) bypass-flowably connected to a surrounding adjustment sleeve (148) that is rotatably connected to the cap (42) for adjusting the discharge rate of the liquid (4).

26. The dispensing device (2) according to claim 24, characterised in that said second flow element is a plate (16) that is arranged downstream of the jacket (20), that is bypass-flowably connected to the cap (42), and that bears sealingly against the plate (16) when the dispensing device (2) is in position of rest; and
wherein the cap (42) is provided with a flow-rate adjustment device (108) that is in contact with the partition wall (46), onto which adjustment device (108) an axial pressure force may act for displacing the partition wall (46) inwards and away from the plate (16), thereby opening the dispensing device (2) for discharging of the liquid (4).

27. The dispensing device (2) according to claim 24, characterised in that said second flow element is a plate (16) that is arranged downstream of the jacket (20), that is bypass-flowably connected to the cap (42), and that bears sealingly against the plate (16) when the dispensing device (2) is in position of rest; and
wherein a push rod (126) allowing bypass-flow is axial-movably arranged within the pipe (7), in which the push rod (126), at the inner and free end thereof, is provided with a sealing body (72) that is arranged wider than the wall opening (48), and that bears positively pressure-sealingly against the upstream side of the wall opening (48) when the dispensing device (2) is in position of rest.

28. The dispensing device (2) according to claim 23, characterised in that said at least one first flow element comprises a jacket (20) provided in each end of several pipes (7′, 7″);
wherein said at least one second flow element comprises several plates (16′, 16″), each of which being provided with a flow aperture (30);
wherein the wall opening (48) is connected to a stay (128) allowing bypass-flow and projecting axially out from the partition wall (46) and through the pipes (7′, 7″) and the flow apertures (30) in the plates (16′, 16″);
wherein the stay (128), in the longitudinal direction thereof, and in sequence, is concentrically surrounded by at least a first pipe (7) provided immediately opposite the partition wall (46), a first plate (16′), a second pipe (7″), a second plate (16″), respectively; and
wherein the outer and free end of the stay (128) is connected to an axial-movably fastener device (130) interconnecting said components (46, 7′, 16′, 7″, 16″) and rendering possible to adjust the discharge rate of the liquid (4).

29. The dispensing device (2) according to any one of claims 11-28, characterised in that the partition wall (46) forms a separate component releasably connected to the cap (42).

30. The dispensing device (2) according to any one of claims 11-28, characterised in that the partition wall (46) is provided with a weakening zone (146) for directing an axial deflection of the partition wall (46) to a specific region thereof.

31. The dispensing device (2) according to any one of claims 11-28, characterised in that the cap (42) is provided with a protective cover (106) that protects the dispensing device (2).

32. The dispensing device (2) according to claim 1, characterised in that the outlet opening (14) of the flow duct (6) is adjustable.

33. The dispensing device (2) according to claim 1, characterised in that the dispensing device (2) is associated to a tapping device, including a discharge cock or a discharge pipe, for the discharging liquid (4).

34. The dispensing device (2) according to claim 1, characterised in that the dispensing device (2) is associated to a closing device (18) for the discharging liquid (4).

35. The dispensing device (2) according to claim 1, characterised in that a storage receptacle (74) is pressurized by gas released from the liquid (4) in the receptacle (74), whereby the released gas acts as a propellant gas (80) for the liquid (4).

36. The dispensing device (2) according to claim 1, characterised in that a storage receptacle (74) is pressurized by a separate pressure source that is connected to the receptacle (74), and that maintains an overpressure therein at least when the liquid (4) is dispensed therefrom via the dispensing device (2).

37. The dispensing device (2) according to claim 36, characterised in that the separate pressure source is a receptacle that is external to the storage receptacle (74), and that contains propellant gas (80).

38. The dispensing device (2) according to claim 36, characterised in that the separate pressure source is a receptacle that is internal to the storage receptacle (74), and that contains propellant gas (80).

39. The dispensing device (2) according to claim 36, 37 or 38, characterised in that the separate pressure source is pressure-adjustable.

40. The dispensing device (2) according to claim 1, characterised in that the dispensing device (2), at the upstream side thereof, is connected to a delivery pipe (86) connecting the dispensing device (2) with a bottom (86) or side of the storage receptacle (74).

41. The dispensing device (2) according to claim 1, characterised in that at least one longitudinal portion of the liquid-flow duct (6) is arranged smooth and with a low roughness coefficient, whereby the longitudinal portion is turbulence-inhibitingly arranged for the discharging liquid (4).

42. The dispensing device (2) according to claim 41, characterised in that said longitudinal portion is mirror-smooth.

43. The dispensing device (2) according to claim 41, characterised in that a viscous material is added to a surface layer of said longitudinal portion, whereby the longitudinal portion is turbulence-inhibitingly arranged for the discharging liquid (4).

44. The dispensing device (2) according to claim 43, characterised in that the viscous material comprises at least one of the following materials: sugar, pectin, starch, gel and modified polymers.

45. The dispensing device (2) according to claim 41, characterised in that the at least one longitudinal portion comprises:
said constricted longitudinal portion (8) of the flow duct (6); and
a longitudinal portion at the outlet opening (14) of the flow duct (6).

46. The dispensing device (2) according to claim 1, characterised in that the flow duct (6) is formed from a flexible material allowing alteration of the flow sectional area of the duct (6) along at least one longitudinal portion thereof.

47. The dispensing device (2) according to claim 1, characterised in that the discharge surface (12) is formed dispersingly for the discharging liquid (4).

48. The dispensing device (2) according to claim 1, characterised in that at least one surface portion of the discharge surface (12) is arranged smooth and with a low roughness coefficient, whereby the surface portion is turbulence-inhibitingly arranged for the discharging liquid (4).

49. The dispensing device (2) according to claim 48, characterised in that said surface portion is mirror-smooth.

50. The dispensing device (2) according to claim 48, characterised in that a viscous material is added to a surface layer of said surface portion, whereby the surface portion is turbulence-inhibitingly arranged for the discharging liquid (4).

51. The dispensing device (2) according to claim 50, characterised in that the viscous material comprises at least one of the following materials: sugar, pectin, starch, gel and modified polymers.

52. The dispensing device (2) according to claim 1, characterised in that the discharge surface (12) comprises at least one of the following surface shapes: plane, concave, convex, circular, tubular, helical and wavy.

53. The dispensing device (2) according to claim 1, characterised in that the discharge surface (12) is arranged as a part of a drinking receptacle (40) into which the liquid (4) is dispensed.

54. The dispensing device (2) according to claim 1, characterised in that the discharge surface (12) is arranged as a part of the outside of a storage receptacle (74).

55. A method for maintaining an overpressure in a propellant gas (80) for a liquid (4) in a storage receptacle (74), the propellant gas (80) existing in a released state from dissolution in the liquid (4), in which said overpressure is to persist throughout the entire dispensing period of the liquid (4) from the receptacle (74), and in which the receptacle (74) is provided with a cap (42) onto which a dispensing device (2) according to any one of claims 11-31 and 41-54 is arranged, characterised in that the method comprises:
to arrange the liquid (4) with a greater saturation of dissolved propellant gas (80) than that of a corresponding reference saturation-level prior to filling the liquid (4) into the receptacle (74); and
thereafter to underfill the receptacle (74) with said liquid (4) to a liquid-level (78) less than a reference liquid-level (82), whereby the receptacle (74) contains a supplemental volume (84) into which propellant gas (80) may be released and contained for maintaining said overpressure throughout said dispensing period.
